(19) United States
(12) Patent Application Publication
(10) Pub. No.: US 2024/0157530 A1
(43) Pub. Date: May 16, 2024

(54) PLIERS ACTUATION ASSEMBLY GROUP, PLIERS AND METHOD FOR ASSEMBLING

(71) Applicant: WEZAG GmbH & Co. KG, Stadtallendorf (DE)

(72) Inventor: Gunthard Gebhard, Amöneburg (DE)

(21) Appl. No.: 18/389,266

(22) Filed: Nov. 14, 2023

(30) Foreign Application Priority Data
Nov. 15, 2022 (EP) 22 207 566.5

(51) Int. Cl. B25B 27/14; H01R 43/042

(52) U.S. Cl. CPC B25B 27/146; H01R 43/042

(57) ABSTRACT

The invention relates to a pliers actuation assembly group (1), pliers and a method of assembling pliers.

A maximum opening angle of the hand levers (2, 3) of the pliers actuation assembly group (1) is defined by a stop part (72), which extends through a hand lever plate (66) and which is accommodated in an elongated hole (69). When the maximum opening angle is reached, the stop part (72) comes to rest against a stop (70) formed by the end portion of the elongated hole (69). The stop part (72) is secured against disassembly by a support of a shoulder (75) of the stop part (72) in one direction on a hand lever plate (66) and of a support surface (77) on another hand lever plate (65), so that the stop part (72) is trapped between these hand lever plates (66, 65).

### CROSS REFERENCE TO RELATED APPLICATIONS

This application claims priority to—co-pending European Patent Application No. EP 22 207 566.5 filed Nov. 15, 2022.

### FIELD OF THE INVENTION

The invention relates to a pair of pliers that can be held and guided by a user's hand and is manually operated by application of forces by a user to hand levers of the pliers.

For the design of the pliers there are the following variants:
a) It is possible that the pliers are crimping pliers, which are used in particular to provide a permanent mechanical connection and an electrical contact. This is preferably done by crimping a plug to a cable or an electrical conductor of any type. Depending on the profile of the dies to be used, different crimping processes can be carried out with the crimping pliers or the crimping machine. For example, it may be a closed crimp in which the conductor is inserted into a closed crimp zone of a plug or into a closed sleeve and crimped by plastic deformation of the crimp zone or sleeve. However, it is also possible that an open crimp is created in which the plug has an open crimp zone into which the conductor can be inserted from above. To give just a few examples which do not limit the invention, the crimping pliers relevant here can be used to crimp workpieces such as
   cable lugs or shoes according to DIN 4623,
   aluminum connectors according to DIN 46329,
   aluminum compression cable lugs or shoes according to DIN 48201,
   squeezed cable shoes or terminals according to DIN 46234,
   pin cable lugs or shoes according to DIN 46230 or
   connectors, plugs or cable lugs or shoes for a connection to a cable or conductor as described in the WEZAG GmbH Werkzeugfabrik product catalog “Werkzeuge für die professionelle Anwendung” with the publication no. 10/11.
   The crimp produced can be, for example, a closed crimp, a hexagonal crimp, a square crimp, a B-crimp, a trapezoidal crimp, a modified trapezoidal crimp, an oval crimp, a mandrel crimp or a double mandrel crimp. An open crimp can e.g. be a V-crimp or B-crimp, a rolled crimp or a double rolled crimp.
   In addition to establishing the electrical connection between cable or conductor and connector, a mechanical connection can be established by means of a so-called insulation crimp. Here, a closed insulation crimp or an open insulation crimp (in particular V-crimp or B-crimp, O-crimp or OV-crimp) can be used. Regarding further information
      for the design of a crimping tool,
      to possible applications of the crimping pliers and/or
      to different possible types of crimp connections, which can be made by means of the crimping tool,
   reference is made to the publication
      “Crimptechnik, Herstellung prozesssicherer Verbindungen von elektrischen Leitern and Steckern” of WEZAG GmbH Werkzeugfabrik, Die Bibliothek der Technik 342, Publisher Moderne Industrie, ISBN 978-3-68236-027-7.
   Crimping pliers in various designs are known, for example, from the publications DE 37 08 727 C2, DE 197 13 580 C2, DE 197 53 436 C2, DE 198 02 287 01, DE 198 07 737 C2, EP 3 208 044 A1 and EP 2 305 428 A1.
b) It is also possible that the pliers are tube pressing pliers that are used to produce a mechanical fluid-tight connection in fluid technology, for example to connect pipes to each other or to fluidic connection plugs. In this case, the tube pressing pliers provide a plastic deformation of the pipes to be connected or of a so-called fitting ensuring the mechanical connection and the fluid-tight seal. Exemplary embodiments of tube pressing pliers can be found in the publications DE 197 09 639 A1, DE 198 34 859 C2, DE 199 24 086 C2, DE 199 24 087 C2, DE 199 63 097 01, DE 103 46 241 B3, EP 2 995 424 A1.

### BACKGROUND OF THE INVENTION

DE 100 56 900 C1 discloses a crimping tool comprising a crimping pliers actuation assembly group and a crimping tool head. The crimping pliers actuation assembly group has two hand levers that are pivotally connected to each other via a pivot bolt. A pulling bar is hinged to each of the hand levers at a distance from the pivot bolt. The crimping pliers actuation assembly group has a forced locking mechanism, by means of which a partially closed position of the hand levers, once reached during a crimping stroke, is secured in a ratchet-like manner and an opening movement of the hand levers is only made possible at the end of the crimping stroke. The crimping pliers head has a pliers head frame to which a fixed die half is fixed and on which a movable die half is guided for displacement in the direction of a crimping axis. The movable die half is supported by a spring device on the die head frame in such a way that the spring device biases the die half in an opening direction. The pliers head frame has frame plates extending parallel to one another, between which the fixed die half is held and the movable die half is guided. For assembling the crimping pliers actuation assembly group to the crimping pliers head, the movable die half has a U-shaped pivot bolt accommodation which is open on one side in the direction of the pivot bolt of the crimping pliers actuation assembly group. Furthermore, the pliers head frame has pulling bar coupling devices that have through bores of the frame plates oriented vertically to the pliers head plane. The pulling bars each have a through bore oriented vertically to the pliers head plane in the end region facing away from the linkage to the hand levers. For assembly, the crimping pliers actuation assembly group is approached to the crimping pliers head in such a way that the pivot bolt, which pivotally couples the hand levers to each other, enters the pivot bolt accommodation. At the same time, the pulling bars are pivoted between the frame plates so that the bores in the frame plates are aligned with the bores in the pulling bars. Coupling bolts or rivets are then inserted into the aligned bores. In the assembled state, the crimping pliers head with the frame plates and the pulling bars arranged therein is trapped between heads of the coupling bolts and a latching ball of the coupling bolt. Remote from the pivot bolt, via which the two hand levers are connected to each other so that they can be pivoted, a transverse bolt is held on one hand lever and extends into an elongated hole in the other hand lever—This elongated hole is curved in such a way that the elongated hole extends concentrically to the pivot axis provided by the pivot bolt. A maximum opening angle of the hand lever is defined by the fact that the transverse bolt comes to rest on an end limitation of the elongated hole.

### SUMMARY OF THE INVENTION

The invention proposes a pliers actuation assembly group. This pliers actuation assembly group can be coupled with a plier head to form (crimping or pressing) pliers. In this case, the coupling can be done at the factory for the same type of pliers actuation assembly groups and pliers heads with the subsequent distribution of the pliers. It is also possible that pliers actuation assembly groups of one type are at the factory coupled with different types of pliers heads, which then allows pliers of different types to be manufactured and distributed, thus increasing the number of the same parts despite the distribution of different types of pliers. It is also possible that a set of pliers is provided for a customer, wherein a pliers actuation assembly group with different types of pliers heads is provided for processing different workpieces and the customer himself can couple a selected pliers head of the several types of pliers heads with a pliers actuation assembly as required.

In the pliers actuation assembly group, this coupling takes place in such a way that, during manual actuation of the pliers actuation assembly group, a (press or crimp) stroke of die halves of the pliers head can be brought about by applying manual forces to hand levers of the pliers actuation assembly group.

The present pliers and the pliers actuation assembly group may be improved in terms of
the manufacturing and/or
the assembly and/or
the disassembly.

Furthermore, a simplified and/or automated method of assembling pliers or a pliers actuation assembly group is proposed.

The pliers actuation assembly group has two hand levers. One hand lever has a first hand lever plate and a second hand lever plate, which may be manufactured by stamping, for example. The first and second hand lever plates are rigidly connected to each other. The other hand lever has a third hand lever plate and a fourth hand lever plate. The third and fourth hand lever plates are also rigidly connected to each other. The hand lever plates are arranged in planes oriented parallel to each other, and it is possible, for example, for one pair of hand lever plates to be arranged directly adjacent to each other and to be capable of performing a relative sliding pivotal movement, while a space may be formed between the two pairs of hand lever plates arranged in this way.

The two hand levers formed in this way are pivotally connected to one another via a pivot bolt. In the case that the pliers actuation assembly group is intended to form crimping pliers, the pivot bolt can simultaneously serve as a pressure bolt or actuation bolt that interacts with a U-shaped pivot bolt accommodation of the crimping pliers head (cp. the prior art DE 100 56 900 C1 mentioned at the beginning).

In one embodiment of the pliers actuation assembly group, the first hand lever plate forms a stop, while a stop part is held and/or guided on the third hand lever plate. An opening angle of the hand levers is limited by the fact that when the opening angle is reached, the stop of the first hand lever plate comes into contact with the stop part held and/or guided on the third hand lever plate. It is possible for two hand lever plates to have a stop, while a stop part is held and/or guided on the other hand lever plates. Preferably, however, the stop and the stop part are provided on one pair of hand lever plates.

One embodiment is in particular based on the realization that, in the case of an assembly of a pliers actuation assembly group according to the prior art, the components of the pliers actuation assembly group are brought into an assembly position in which retaining bores, guiding bores and/or connecting bores thereof are aligned with one another, so that a coupling screw, a coupling pin, a coupling rivet, the pivot bolt or the transverse bolt can be inserted therein. A coupling screw must then protrude from the component coupled in this way to be secured by means of a nut, or has to be screwed directly to a component. A coupling pin, the pivot bolt or the transverse bolt must be secured in particular by an interference fit in at least one component, which requires an increased joining force. A rivet must be expanded to be secured in at least one component. These coupling technologies are costly and may not be suitable for partially or fully automated assembly.

The invention also proposes a new option for mounting and securing the stop part and/or the pivot bolt:

In one embodiment, the stop part (and/or the pivot bolt) has a shoulder. In the assembled state of the pliers actuation assembly group, the shoulder is in contact with the third hand lever plate. The stop part (or the pivot bolt) is supported via this abutment with the shoulder on the third hand lever plate in outward direction, i.e. with respect to a movement out of the pliers actuation assembly group vertically to the pivot plane of the hand levers. This embodiment thus results in an alternative support in this direction that is not based on a securing by a threaded connection, friction locking in an accommodating bore or a rivet. The mentioned contact of the shoulder with the third hand lever plate and the resulting outward support can be the only securing of the stop part or pivot bolt in this direction with regard to unintentional disassembly, or further cumulative securing measures can be taken, where the screwed connection, press connection or riveted connection described above can additionally be used.

For the arrangement of the first hand lever plate and the third hand lever plate, there are various options, some of which being mentioned below by way of example only, without any limitation to these examples being intended:

For a first option, the first hand lever plate is on the outside. In this case, the hand lever plates can be arranged in a direction vertical to the pivot plane of the hand levers in the sequence: first hand lever plate—third hand lever plate—(intermediate space if necessary)—second hand lever plate—fourth hand lever plate. Alternatively, it is possible that the hand lever plates are arranged in this direction in the sequence: first hand lever plate—third hand lever plate—(if necessary, intermediate space)—fourth hand lever plate, second hand lever plate.

For this option, one embodiment relates to the design of the stop part. For this proposal, the stop part has a first longitudinal section and a second longitudinal section that are interconnected via the shoulder. Preferably, the two longitudinal sections merge directly into each other via the shoulder. It is possible that the first longitudinal section is cylindrical and has a smaller diameter than the second longitudinal section, in which case, when the longitudinal axes of the longitudinal sections are aligned, the shoulder has a circular ring shape. The first longitudinal section extends through the third hand lever plate, whereby holding and/or guiding of the stop part in the third hand lever plate can be provided. In an end region protruding from the third hand lever plate, the first longitudinal section interacts with the stop of the first hand lever plate. While the second longitudinal section is then supported in a first direction vertical to the pivot plane of the hand levers via the shoulder on the third hand lever plate, the second longitudinal section comprises a support surface in the end region facing away from the first longitudinal section which comes into contact with the third or fourth hand lever plate (depending on the order of the hand lever plates) in the opposite direction. In this way, the stop part is trapped between the third hand lever plate and the second or fourth hand lever plate in both directions vertical to a pivot plane of the hand levers.

For the other option, the third hand lever plate is located externally. In this case, the hand lever plates can be arranged in a direction vertical to the pivot plane of the hand levers in a sequence: third hand lever plate—first hand lever plate—(if necessary intermediate space)—second hand lever plate, fourth hand lever plate. Alternatively, it is possible that in the direction vertical to the pivot plane of the hand levers, the hand levers plates are arranged in the sequence: third hand lever plate—first hand lever plate—(if necessary intermediate space)—fourth hand lever plate—second hand lever plate.

In this case, too, the stop part can have a first and second longitudinal section, which can also each be cylindrical with a smaller diameter of the first longitudinal section than the diameter of the second longitudinal section and a then annular shoulder. The first longitudinal section extends into the third hand lever plate, whereby holding and/or guiding of the stop part on the third hand lever plate can be provided. The second longitudinal section extends through the first hand lever plate. The second longitudinal section has a support surface in the end region facing away from the first longitudinal section. In a first direction vertical to the pivot plane of the hand levers the stop part is then supported via the shoulder on the third hand lever plate, while the support surface formed by the second longitudinal section comes into contact with the second or fourth hand lever plate. In this way, the stop part is trapped in both directions vertical to the pivot plane of the hand levers between the third hand lever plate and the second or fourth hand lever plate.

In this case, too, the stop part can be secured exclusively with regard to undesirable disassembly via the support on the one hand via the shoulder and on the other hand via the support surface, or further cumulative connecting or securing measures can be taken.

Generally, the stop part can have any geometry and, for example, can also have a non-circular cross-section. For both options mentioned above, the stop part can also be a bolt with an arbitrary cross-section, in particular a first cylindrical longitudinal section with a first diameter and a second cylindrical longitudinal section with a second diameter, whereby the second diameter is larger than the first diameter. The shoulder is then formed between the longitudinal sections, which is annular for the coaxial arrangement of the two longitudinal sections.

Generally, the stop of the first hand lever plate can be formed, for example, by an edge sided protrusion of the hand lever plate. For a particular proposal, the stop of the first hand lever plate is formed by an edge boundary of a (blind or through) recess of the first hand lever plate. The recess may have an open-edged or closed-edged cross-section.

For the shape of the cross-section of the recess, there are many arbitrary options. For one proposal, the recess is an elongated hole. This elongated hole preferably has a curved longitudinal axis, which is arranged concentrically to the pivot axis of the hand levers defined by the pivot bolt. Thus, for the first option, the end portion of the first longitudinal section protruding from the third hand lever is accommodated in the elongated hole. For the second option, a longitudinal section part of the second longitudinal section adjacent to the shoulder is accommodated in the elongated hole. For an opening stroke of the pliers actuation assembly group, the stop part then moves along the elongated hole. When the maximum opening angle of the hand levers is reached, the stop part comes to rest against an end sided limitation of the elongated hole.

Another aspect relates to mounting and securing the pivot bolt. In this regard, one embodiment proposes that the pivot bolt has two shoulders trapped between two hand lever plates. In this case, the pivot bolt can be secured against unwanted disassembly in both directions vertical to the pivot plane of the hand levers by a loose contact of the shoulders with the two hand lever plates, which can be the exclusive securing or can be the case with cumulative securing measures.

Proposed are also pliers, in particular crimping pliers, in which a pliers actuation assembly group as explained above is coupled to a pliers head in such a way that a stroke of die halves of the pliers head can be brought about by means of a manual actuation of the pliers actuation assembly group.

Proposed is also a method of assembling a pliers actuation assembly group as previously explained or pliers. In this method, the following method steps are performed:
a) The pivot bolt is inserted into a bearing eye of the first hand lever plate. It is possible that the pivot bolt has a shoulder via which the pivot bolt is secured against unwanted disassembly in the insertion direction. It is possible that the pivot bolt is inserted into the bearing eye of the first hand lever plate with a play or a clearance or a transition fit.
b) The third hand lever plate is then pushed onto the pivot bolt by inserting the pivot bolt held on the first hand lever plate into a bearing eye of the third hand lever plate.
c) The stop part, which is designed according to the first option mentioned above, is inserted in such a way that the first longitudinal section extends into the recess or elongated hole of the first hand lever plate and through a holding and/or guiding bore of the third hand lever plate and the shoulder of the stop part comes into contact with the third hand lever plate. This secures the stop part against unwanted disassembly in the insertion direction.
d) The second hand lever plate and the fourth hand lever plate are now pushed in a sliding way onto the pivot bolt, completing the pivot bearing which allows the hand levers to be pivoted. With the sliding movement of the second hand lever plate and the fourth hand lever plate, a blockade of the end-sided support surface of the second longitudinal section of the stop part against an undesired disassembly is provided by the second hand lever plate or fourth hand lever plate. It is possible here that the second hand lever plate or fourth hand lever plate comes into direct contact with this support surface in order to ensure this blockade, or that a certain amount of play remains between the support surface and the second or fourth hand lever plate.
e) Finally, the first and second hand lever plates are fixed to each other and the third and fourth hand lever plates are fixed to each other. After this fixation, the stop part is trapped between the third hand lever plate and the second hand lever plate or fourth hand lever plate as a result of interaction with the shoulder and the support surface. Although the stop part may only be loosely connected to the hand lever plates, a reliable assembly is performed for which the stop part can only be disassembled when the fixation of the first and second hand lever plates as well as the fixation of the third and fourth hand lever plates is released. In a corresponding way, the pivot bolt can also have a further shoulder via which the pivot bolt is supported on the outer hand lever plate of the second hand lever plate and the fourth hand lever plate, so that the pivot bolt is also trapped between two outer hand lever plates. However, it is also possible for the pivot bolt to be supported via a shoulder on a hand lever plate of a hand lever, while the pivot bolt is then connected to the other hand lever plate of this hand lever via an interference or press fit, while the pivot bolt forms a bearing clearance with bearing eyes of the other hand lever.

In principle, the aforementioned method steps can be carried out in any order or in the sequence mentioned above.

It is possible that further method steps are carried out between the method steps explained above. Of these optional further method steps, only a few options are mentioned below by way of example:
It is possible that before the second hand lever plate and the fourth hand lever plate (cf. d)) are pushed on, spacers are inserted in the accommodating recesses of the first and third hand lever plates, which are used to specify the distance between the hand lever plates. These spacers can, for example, have accommodating pins in one end section that are press-fitted into accommodating bores of the hand lever plates, or the spacers can be designed as rivets that can be clamped to the accommodating bores in the hand lever plates. The spacers can thus also be used to fix the hand lever plates according to e).
It is also possible that, before the second and fourth hand lever plates are pushed on (see d)), pivots pins of pulling bars are inserted in bearing eyes of the first and third hand lever plates. When the second and fourth hand lever plates are slid on, the pivot pins of the pulling bars arranged on the other side enter the bearing eyes of the second and fourth hand lever plates. In this case, the pulling bars (while being supported for being pivoted) are also trapped between the hand lever plates, which means that the pulling bars can only be disassembled if the fixation of the hand lever plates to each other is released.
Alternatively or cumulatively, it is possible that before the second hand lever plate and the fourth hand lever plate are pushed on (see d)) components of a forced locking mechanism and/or a spring for biasing a locking pawl of the forced locking mechanism are connected to the first hand lever plate and/or the third hand lever plate by pins or webs entering into an accommodating bore of the first hand lever plate and/or third hand lever plate. When the second hand lever plate and the fourth hand lever plate are pushed on, further webs or pins can then be accommodated in accommodations of the second and/or fourth hand lever plate, or a shoulder can be supported on the second and/or fourth hand lever plate. At least one component of the forced locking mechanism or a spring can then be mounted in this way and can be secured against disassembly. Disassembly is only possible when releasing the fixing of the hand lever plates to each other.

Preferably, here the previously explained joining with the joining movements a), b), c) and d) (as well as the joining according to the aforementioned supplemented optional assembly steps) is carried out with a joining direction that is oriented vertically to the pivot plane of the hand levers. Under certain circumstances, this can enable or simplify fully or partially automated assembly.

Advantageous further embodiments of the invention result from the patent claims, the description and the drawings.

The advantages of features and of combinations of several features mentioned in the description are merely exemplary and can be affected alternatively or cumulatively, without the advantages necessarily having to be achieved by embodiments according to the invention.

With regard to the disclosure—not the scope of protection—of the original application documents and the patent, the following applies: Further features can be taken from the drawings—in particular the geometries shown and the relative dimensions of several components to each other as well as their relative arrangement and effective connection. The combination of features of different embodiments of the invention or of features of different patent claims is also possible in deviation from the selected referrals of the patent claims and is hereby suggested. This also applies to such features which are shown in separate drawings or are mentioned in the description thereof. These features can also be combined with features of different patent claims. Likewise, features listed in the patent claims may be omitted for further embodiments of the invention, which does not apply to the independent patent claims of the granted patent.

The features mentioned in the patent claims and the description are to be understood with respect to their number in such a way that exactly this number or a larger number than the number mentioned is present, without requiring an explicit use of the adverb “at least”. Thus, for example, when one element is mentioned, this is to be understood as meaning that exactly one element, two elements or more elements are present. The features listed in the patent claims may be supplemented by further features or may be the only features that the subject matter of the respective patent claim has.

The reference signs contained in the patent claims do not represent a limitation of the scope of protected by the patent claims. They merely serve the purpose of making the patent claims easier to understand.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

In the following, the invention is further explained and described with reference to preferred embodiments shown in the figures.

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows an exploded view of a pliers actuation assembly group of a pair of pliers.

FIG. 2 shows a three-dimensional representation of the pliers actuation assembly group of a pair of pliers according to FIG. 1 in an assembled state.

FIG. 3 shows an exploded view of a pliers head of a pair of pliers that can be used together with a pliers actuation assembly group according to FIGS. 1 and 2.

FIG. 4 shows a three-dimensional representation of the pliers head of a pair of pliers according to FIG. 3 in an assembled state.

FIGS. 5 to 8 show in three-dimensional representations an assembly and operation of pliers with a pliers actuation assembly group according to FIGS. 1 and 2 and a pliers head according to FIGS. 3 and 4.

FIG. 9 shows a partially assembled state of pliers according to FIGS. 5 to 8 in a top view on the pliers head plane.

FIG. 10 shows a sectional view of the pliers according to FIGS. 5 to 9 cut parallel to the pliers head plane.

FIG. 11 shows the pliers according to FIGS. 5 to 10 in a closed position in a top view on the pliers head plane.

FIG. 12 shows the pliers according to FIGS. 5 to 11 in the closed position in sectional view cut parallel to the pliers head plane.

FIG. 13 shows a three-dimensional representation of a pulling bar as it can be used in a pliers actuation assembly group according to FIGS. 1 and 2 and pliers according to FIGS. 5 to 12.

FIG. 14 shows an exploded view of another embodiment of a pliers actuation assembly group.

FIG. 15 shows a three-dimensional representation of the assembled pliers actuation assembly group of FIG. 14.

FIG. 16 shows an exploded view of a pliers head that can be used together with a pliers actuation assembly group according to FIGS. 14 and 15.

FIG. 17 shows the pliers head according to FIG. 16 in assembled condition in a three-dimensional representation.

FIGS. 18 to 21 show pliers, which have a pliers actuation assembly group according to FIGS. 14 and 15 and a pliers head according to FIGS. 16 and 17, in different assembly and operating states in a top view on the pliers head plane, partially in a cut state with sectional guidance parallel to the pliers head plane.

FIGS. 22 and 23 in three-dimensional representations show different possible configurations of pulling bars of a pliers actuation assembly group according to FIGS. 14 and 15 and of pliers according to FIGS. 18 to 21.

FIG. 24 shows a three-dimensional exploded view of a pliers actuation assembly group.

FIG. 25 shows a three-dimensional representation of a stop part of a pliers actuation assembly group of FIG. 24.

FIG. 26 shows a three-dimensional representation of a pivot bolt of a pliers actuation assembly group of FIG. 24.

FIGS. 27 to 37 show different mounting states for an assembly of a pliers actuation assembly group of FIG. 24.

FIG. 38 shows a three-dimensional exploded view of another pliers actuation assembly group.

### DETAILED DESCRIPTION

In the following description, components or features which correspond to each other or are similar in terms of design, geometry and/or function are partially labelled with the same reference numbers, in which case they may be distinguished from one another by means of a supplementary letter a, b, . . . . In this case, the components or features can be referred to with or without the supplementary letter, whereby without using the supplementary letter then one component or feature, several components or features or all components or features can be addressed.

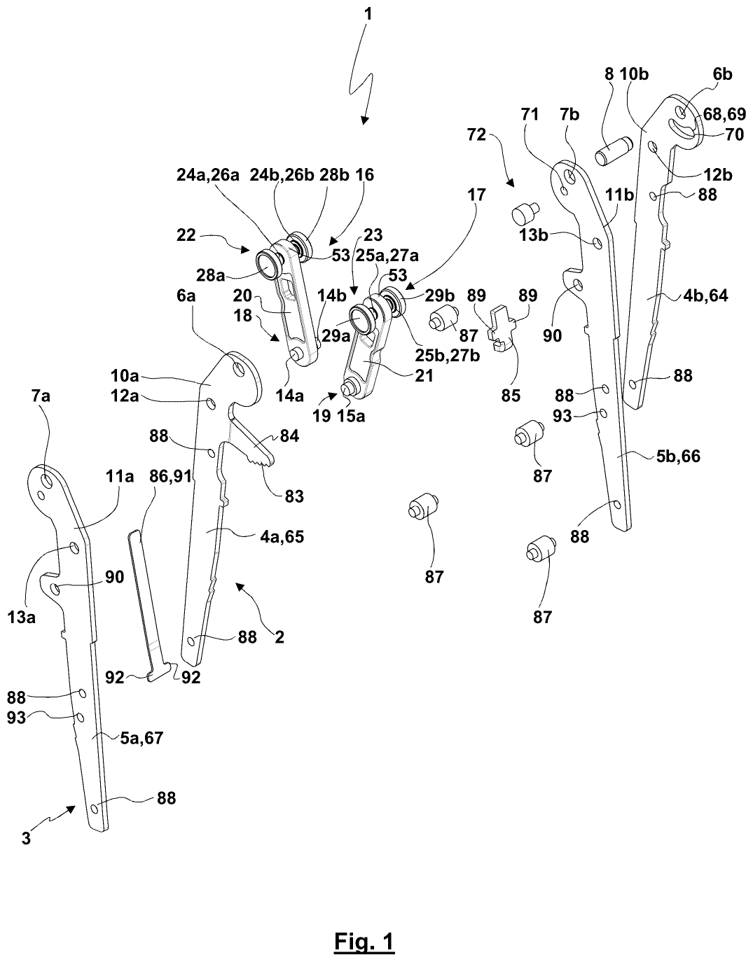

FIG. 1 shows a pliers actuation assembly group 1. The pliers actuation assembly group 1 has hand levers 2, 3. The hand lever 2 is formed with two hand lever plates 4a, 4b. Correspondingly, the hand lever 3 is formed with two hand lever plates 5a, 5b.

In the end region facing away from the grip part of the hand levers 2, 3, the hand levers 2, 3 each have a bearing eye 6, 7, which are formed here as bearing eyes 6a, 6b of the hand lever plates 4a, 4b and as bearing eyes 7a, 7b of the hand lever plates 5a, 5b. The bearing eyes 6, 7 are bores through which a pivot bolt 8 extends. In this way a pivot bearing 9 is formed. By the pivot bearing 9, the hand levers 2, 3 are pivotably connected to each other so that they can perform an opening and closing movement for causing a (crimping or pressing) stroke and an opening stroke.

The hand levers 2, 3 are preferably slightly angled relative to one another with angular sections 10, 11. In the region of the angled sections 10, 11, the hand levers 2, 3 have bores 12, 13. In these bores 12, 13, pivot pins 14, 15 of pulling bars 16, 17 are accommodated. In this way pivot bearings 18, 19 are formed, by which the pulling bars 16, 17 linked for being pivoted to the hand levers 2, 3. For the illustrated embodiment, the pulling bars 16, 17 each have pivot pins 14a, 14b and pivot pins 15a, 15b on both sides of a base body 20, 21, respectively, which are received in bores 12a, 12b and bores 13a, 13b of the hand lever plates 4a, 4b and 5a, 5b, respectively.

The pulling bars 16, 17 are rectilinear and of strut or rod-like design. In the end regions facing away from the pivot pins 14, 15, the pulling bars 16, 17 each have a coupling element 22, 23. On both sides of their base bodies 20, 21, the coupling elements 22, 23 have coupling element parts 24a, 24b and 25a, 25b, respectively, which are designed here as coupling pins 26a, 26b and 27a, 27b, respectively, and have extensions 28a, 28b, 29a, 29b in the end regions facing away from the base body 20, 21.

For the embodiment shown in FIG. 1, the pulling bars 16, 17 are integrally formed or monolithic so that the base bodies 20, 21, the pivot pins 14, 15 and the coupling elements 22, 23 are integral parts of a single structural component.

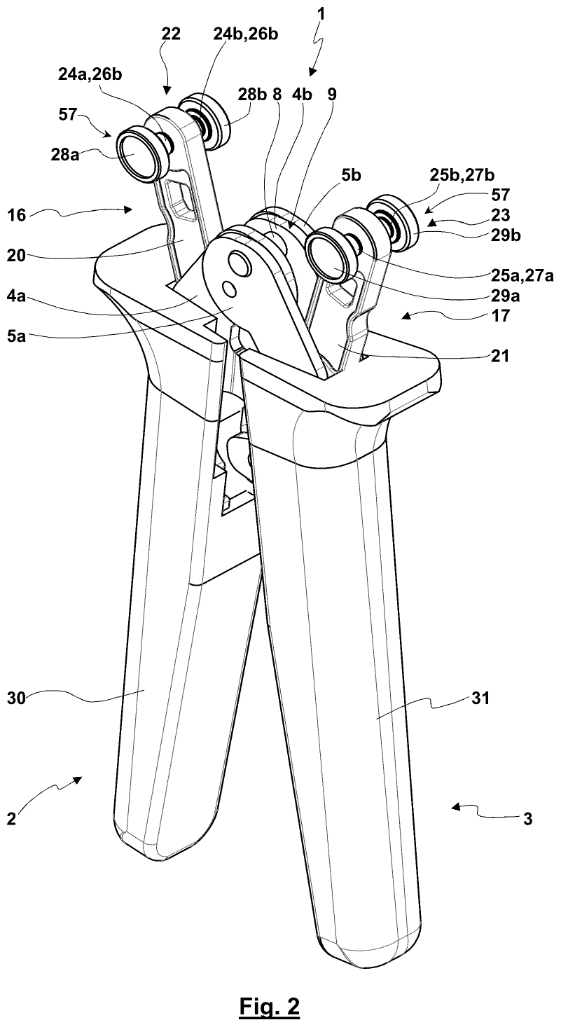

FIG. 2 shows the pliers actuation assembly group 1 in the assembled state. Here, elastomeric handles 30, 31 are additionally pushed onto the hand levers 2, 3. It can be seen here that the pulling bars 16, 17 with the coupling elements 22, 33 protrude freely upwards from the pliers actuation assembly group 1. The pulling bars 16, 17 can be pivoted freely as a result of the linkage via the pivot bearings 18, 19 to the hand levers 2, 3. Furthermore, the pivot bolt 8 is freely accessible from above between the hand lever plates 4, 5.

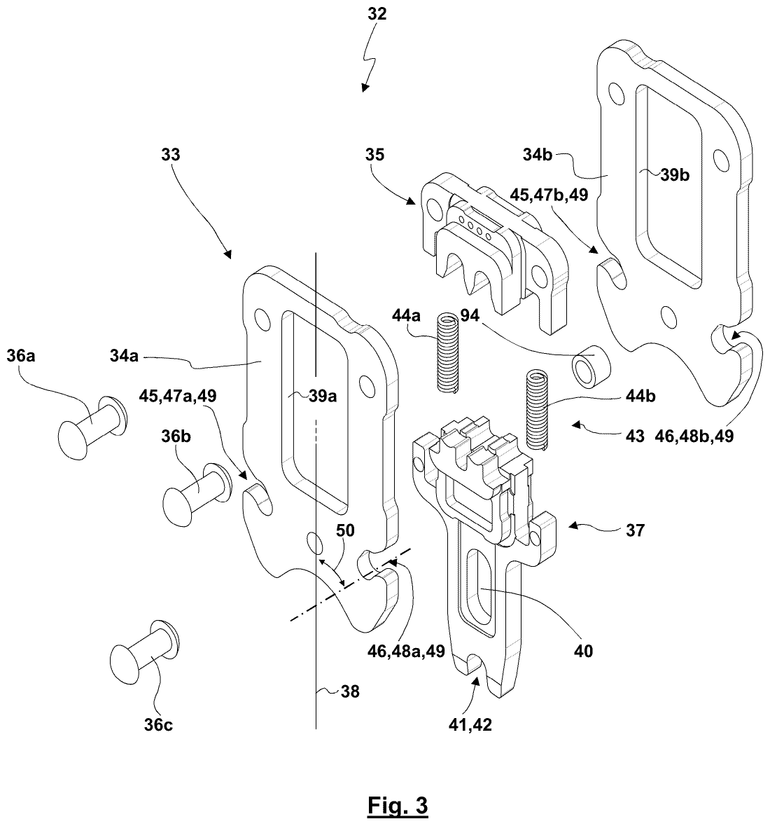

FIG. 3 shows a three-dimensional exploded view of a pliers head 32. The pliers head 32 has a pliers head frame 33, which here comprises frame plates 34a, 34b. A fixed die half 35 is arranged between the frame plates 34a, 34b. Connecting elements, in particular rivets 36a, 36b, connect the frame plates 34a, 34b and the fixed die half 35 arranged between them to form a fixed structural unit. The two frame plates 34a, 34b are further connected by a further rivet 36c.

The plier head 32 further has a movable die half 37. The movable die half is guided for being displaced on the plier head frame 33 in the direction of a crimping or pressing axis 38, which can be done, for example, by the frame plates 34a, 34b having recesses 39a, 39b that form lateral guide surfaces on which guide surfaces of the movable die half 37 are guided. The rivet 36c can extend with the sleeve 94 through a recess 40 of the movable die half 37 and provide additional guidance and/or a limitation of the movement of the movable die half 37.

In the end region facing away from the fixed die half 35, the movable die half 37 has a pivot bolt accommodation 41. In the embodiment shown, the pivot bolt accommodation 41 is designed as a U-shaped recess 42, which has an open-edged cross section. The pivot bolt accommodation 41, in this case the recess 42, is open downwards, i.e. in the state mounted on the pliers actuation assembly group 1 in the direction of the pliers actuation assembly group 1.

The pliers head 32 comprises a spring device 43, which is formed here with two springs 44a, 44b. The springs 44 are designed as compression springs. One spring base of the springs 44 is supported on the pliers head frame 33 and/or the fixed die half 35, while the other spring base of the springs 44 is supported on the movable die half 37. In the open position, in which the die half 37 has the maximum distance from the die half 35, the bias of the spring device 43 is minimal, while the bias of the spring device 43 increases as the die half 34 approaches the die half 35 over the crimping or pressing stroke. For the illustrated embodiment, the springs 44 are symmetrically arranged on both sides adjacent die surfaces of the die halves 35, 37 between which the workpiece is crimped or pressed.

The pliers head frame 33 has coupling recesses 45, 46. Here, the frame plates 34a, 34b form coupling recess parts 47a, 47b of the coupling recess 45 and coupling recess parts 48a, 48b of the coupling recess 46.

For the embodiment shown, the coupling recesses 45, 46 and the coupling recess parts 47, 48 are formed as elongated holes 49 open on one side in the outer end region. In this case, the elongated holes 49 are inclined at an acute angle 50 with respect to the crimping or pressing axis 38, the angle 50 preferably being in the range of 20-80° or 30 to 60° or 35 to 55°. Here, the acute angle 50 is oriented such that the apex points towards the pliers actuation assembly group 1, so that an entry movement from the outside into the elongated hole 49 has a component oriented towards the pivot bolt accommodation 41 and the pliers actuation assembly group 1. The elongated hole 49 may have non-parallel lateral boundaries that have any curvilinear shape when projected onto the pliers head plane.

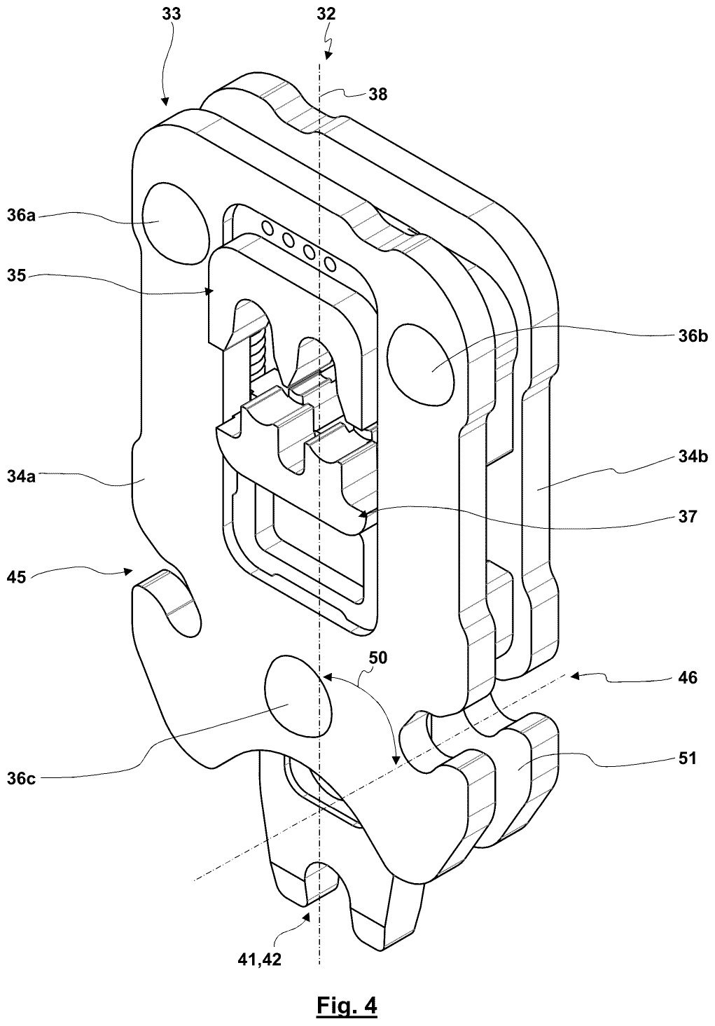

As a result of the distance between the frame plates 34, there is a gap 51 between the frame plates 34 (cf. FIG. 4). This gap 51 also exists between the pairs of coupling recess parts 47a, 47b and coupling recess parts 48a, 48b. In the area of the rivets 36a, 36b, the gap 51 between the frame plates 34 is defined by the die half 35. Instead, the rivet 36c is surrounded by a sleeve 94, which defines the distance between the frame plates 34 in the area of the rivet 36c.

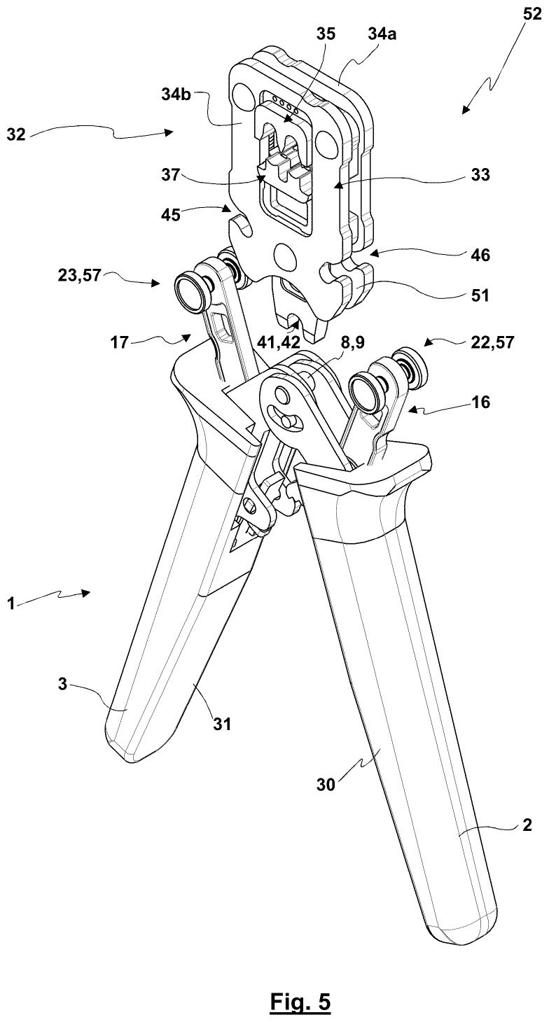

FIG. 5 shows the pliers actuation assembly group 1 and the pliers head 32 before assembly.

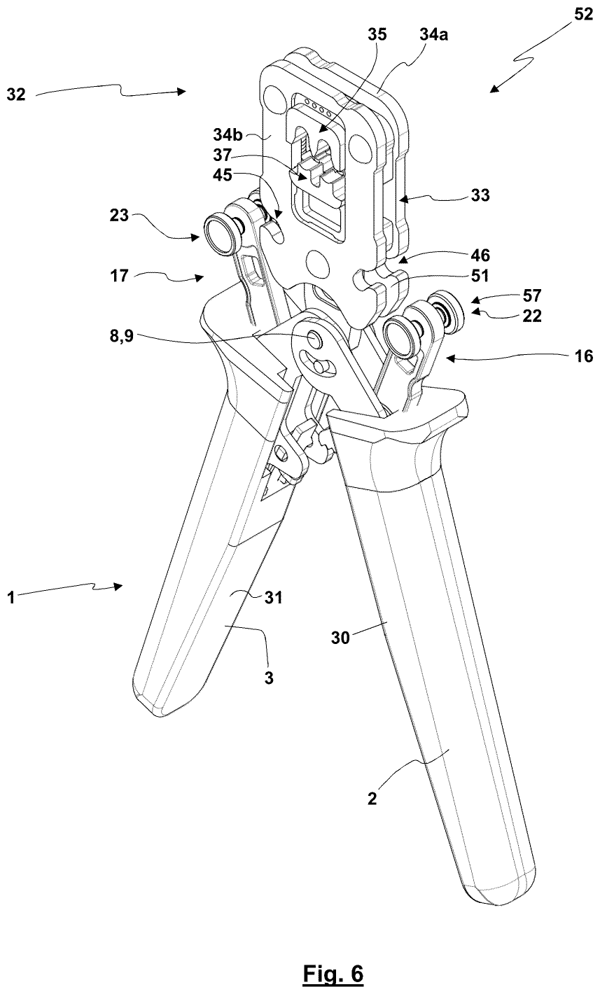

Referring to FIG. 6, for assembly, the pliers actuation assembly group 1 is approached to the pliers head 32 from below such that the pivot bolt 8 enters the pivot bolt accommodation 41 from below. By bringing the pivot bolt 8 into contact with the bottom of the pivot bolt accommodation 41, an actuating force can be transferred between the pliers actuation assembly group 1 and the pliers head 32, which strives to push the movable die half 37 upward. However, in the partially assembled state shown in FIG. 6, the pulling bars 16,17 are still in a pivoted position in which they are laterally of the pliers head frame 33 without being coupled.

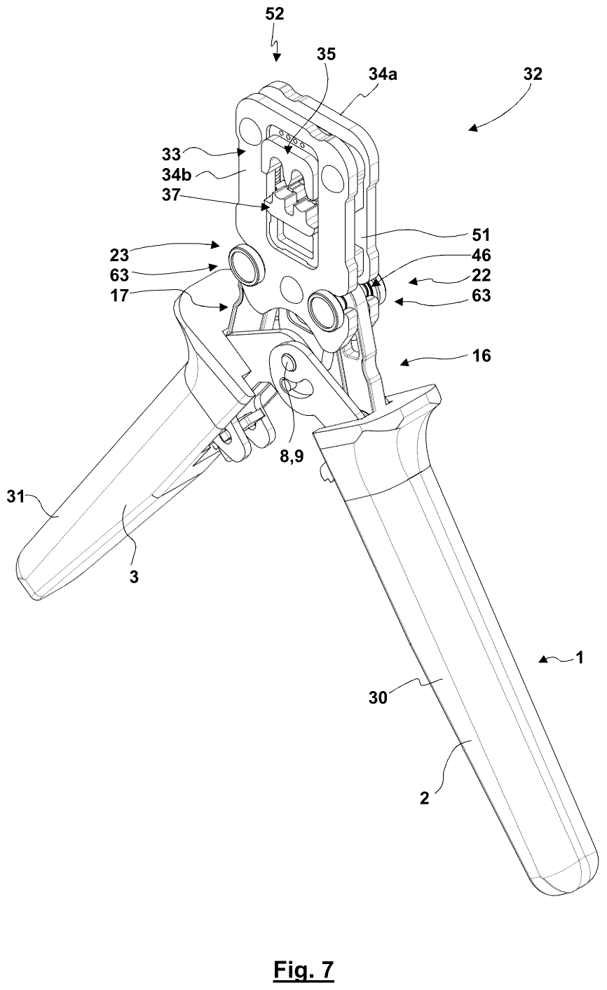

For further assembly, as shown in FIG. 7, the pulling bars 16, 17 are pivoted inward towards each other and towards the pliers head frame 33 until the coupling elements 22, 23 of the pulling bars 16, 17 enter the coupling recesses 45, 46 of the pliers head frame 33. In the present case, the coupling pins 26a, 26b enter the coupling recess parts 47a, 47b of the frame plates 34a, 34b and the coupling pins 27a, 27b of the pulling bar 17 enter the coupling recess parts 48a, 48b of the pliers head frame 33. At the same time, the base bodies 20, 21 of the pulling bars 16, 17 enter the intermediate space 51 formed between the frame plates 34a, 34b.

The length of the pulling bars 16, 17 is dimensioned such that the explained entry of the coupling elements 22, 23 into the coupling recesses 45, 46 can only occur when a movement of the movable die half 37 in the closing direction occurs. This movement is greatest when the coupling elements 22, 23 enter straight into the openings of the coupling recesses 45, 46, while a return movement of the movable die half 37 in the opening direction can occur when the coupling elements 22, 23 move into the interior of the coupling recesses 45, 46 to the bottom thereof. The partial closing movement required for the entry of the coupling elements 22, 23 into the coupling recesses 45, 46 is smaller than the crimping or pressing stroke and is, for example, less than 20%, less than 15% or less than 10% of the crimping or pressing stroke. At the end of the entry movement, when the coupling elements 22, 23 rest against the bottom of the coupling recesses 45, 46, the movable die half 37 can again reach the initial position, i.e. the maximum open position. Preferably, however, a partial closing stroke then remains, which may be, for example, less than 10% or less than 5% of the crimping or pressing stroke. The explained partial closing movement and the described partial closing positions are accompanied by a loading of the spring device 43. The spring force of the spring device 43 causes the coupling elements 22, 23 to be drawn into the coupling recesses 45, 46 and to be pressed with a spring force component against the bottom of the coupling recess 45, 46. Disassembly with the coupling elements 22, 23 being moved out of the coupling recesses 45, 46 thus requires overcoming this spring force component, which is generated by the spring device 43.

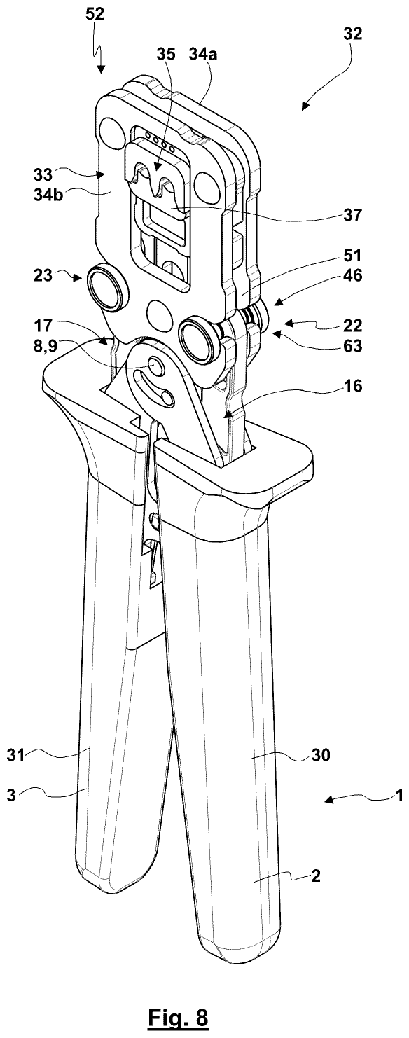

When pliers 52 formed by assembling the pliers actuation assembly group 1 and the plier head 32 as shown in FIG. 7 is used to crimp or press a workpiece, the operator closes the hand levers 2, 3, causing a passing of the crimping or pressing stroke. FIG. 8 shows the pliers 52 at the end of the crimping or pressing stroke, at which the hand levers 2, 3 and the die halves 35, 37 are closed.

In FIGS. 7 and 8, it can be seen that in the assembled state in a direction vertical to the pliers head plane the frame plates 34a, 34b are each trapped between the base bodies 20, 21 and an extension 28, 29.

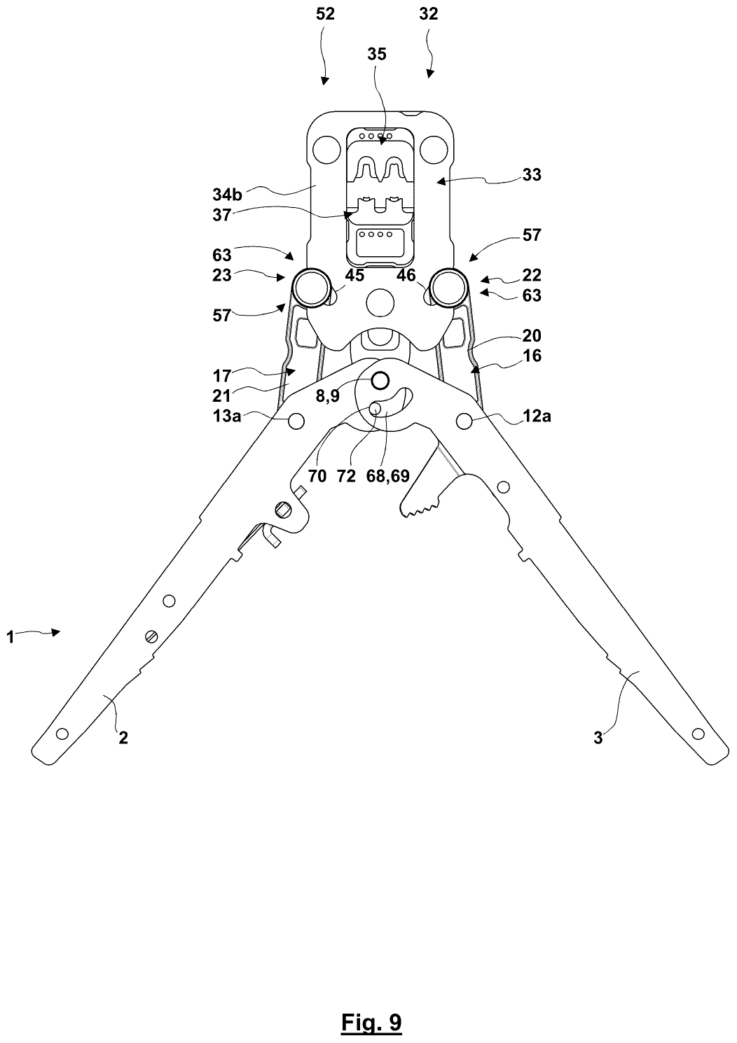

FIG. 9 shows the partially assembled state of the pliers 52 at the time the coupling elements 22, 23 enter the coupling recesses 45, 46, with some parts of the pliers 52 omitted here for better illustration.

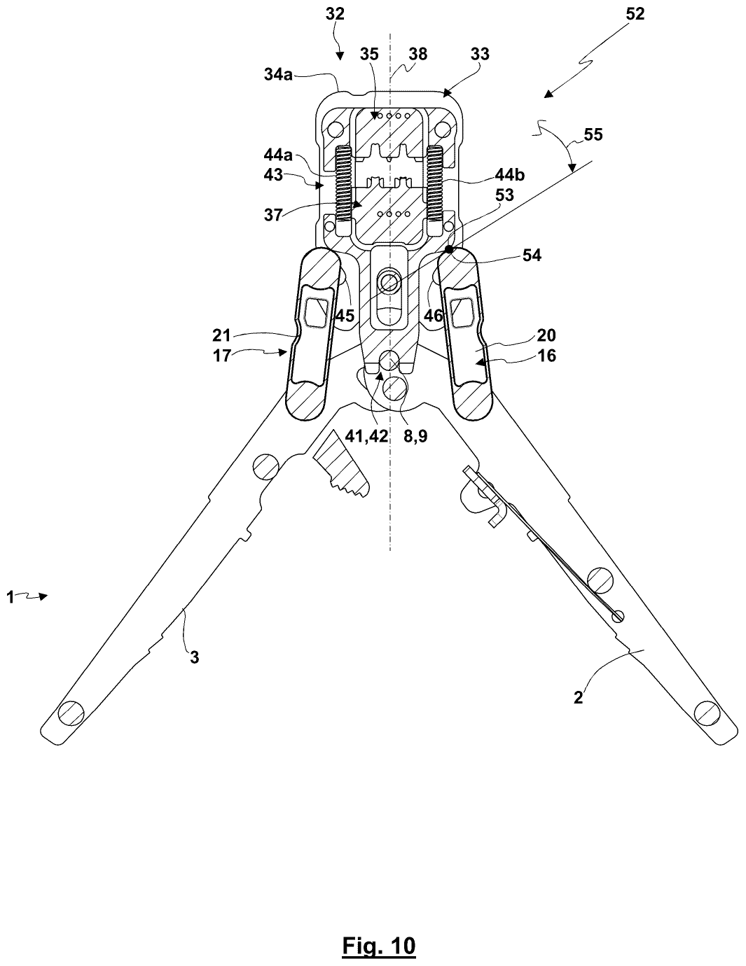

In a corresponding partial assembly position, FIG. 10 shows the pliers 52 in a sectional view in the plane of the dies 35, 37 and in the plane of the pliers head, in which the interaction of the pivot bolt 8 with the pivot bolt accommodation 41 and the contact force as a result of the springs 44a, 44b can be seen.

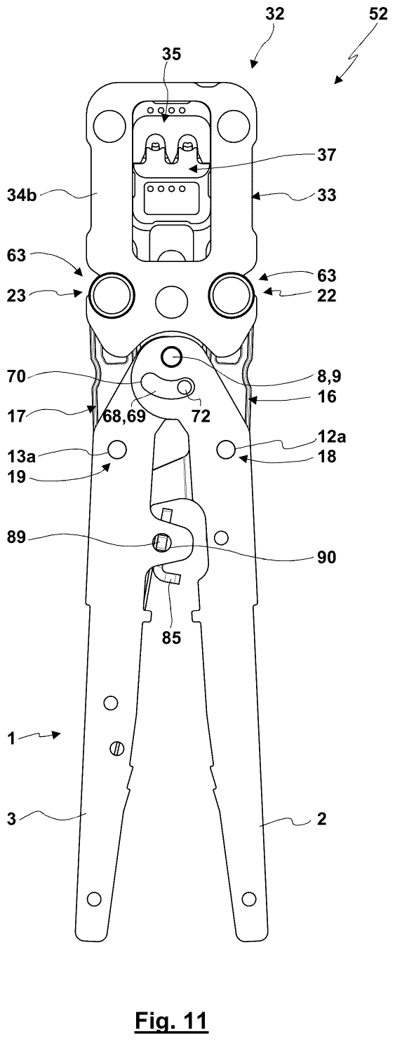

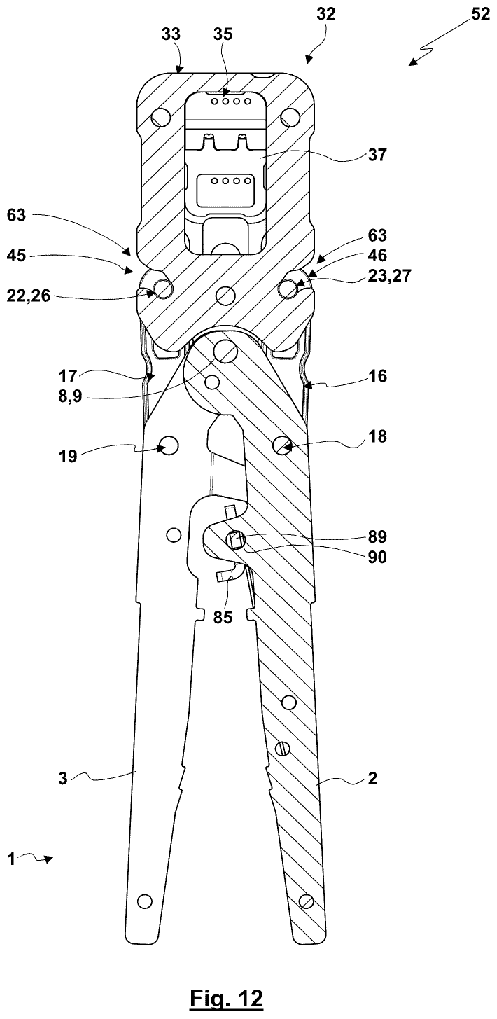

Finally, FIGS. 11 and 12 show illustrations corresponding to FIGS. 9 and 10, but here the pliers 52 are shown in the closed position at the end of the crimping or pressing stroke.

As an optional feature, when the coupling elements 22, 23 enter the coupling recesses 45, 46 or even earlier when the pulling bars 16, 17 approach the pliers head frame 33, a contact surface 53 of the pulling bars 16, 17, 4 of the base body 20, 21 can come into contact with a contact surface 54 of the movable die half 37 (cf. FIG. 10). An actuating force applied to the pulling bars 16, 17, which pivots the pulling bars 16, 17 inward, is converted by the contact surfaces 53, 54 into an actuating force component that provides an assembly assistance force that strives to move the movable die half 37 in the closing direction and to compress the springs 44a, 44b. For this purpose, the contact surfaces 53, 54 are inclined at an acute angle 55 with respect to the crimping or pressing axis 38. During the insertion movement, the contact surfaces 53, 54 slide along each other. The contact surfaces 53, 54 can also be curved as desired, resulting in an angle 55 that varies during the insertion movement.

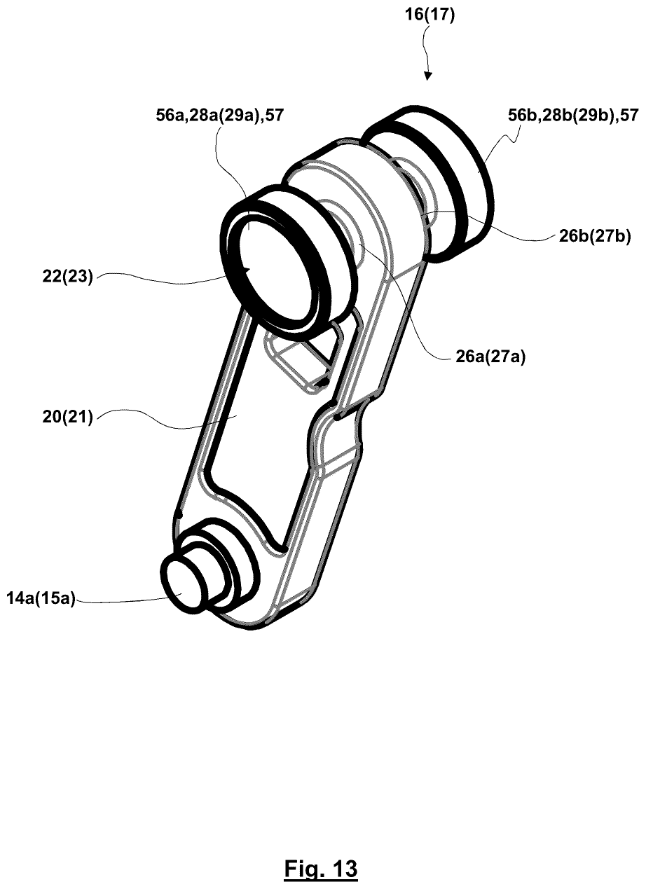

FIG. 13 is a three-dimensional single component drawing of a pulling bar 16, 17, which forms the base body 20, 21, the pivot pins 14a, 14b, 15a, 15b and the coupling elements 22, 23 as an integral, one-piece component. It can be seen here that the extensions 28, 29 are formed as disc bodies 56. It is possible that the extensions 28, 29 or disc bodies 56 form actuating elements 57 which simplify assembly and disassembly by providing that actuating forces required for assembly and disassembly and movement of the pulling bars 16, 17 can be applied to them by the user.

The coupling recesses 45, 46 can be of any shape. They do not have to be formed as an elongate hole 49. Rather, it is crucial that the coupling recesses 45, 46 form upwardly oriented hooks or suspension eyes in which the coupling elements 22, 23 can be suspended.

The embodiment according to FIGS. 1 to 13 represents a possible embodiment of the above “first variant”.

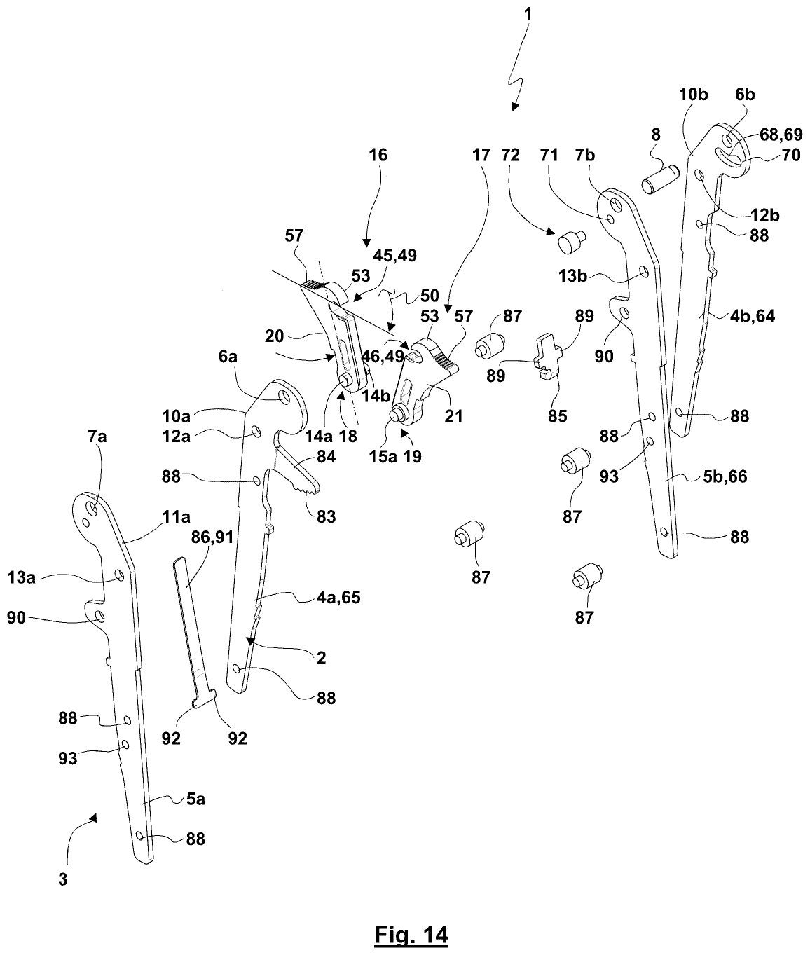

In FIGS. 14 to 21, a further embodiment of the pliers actuation assembly group 1, the pliers head 32 and the pliers 52 formed with the pliers actuation assembly group 1 and the pliers head 32 is shown, which represents a possible embodiment of the above “second variant”. Here, the same reference numbers are used for structurally or functionally corresponding or similar components and features as in FIGS. 1 to 13, and reference is made to the description thereof.

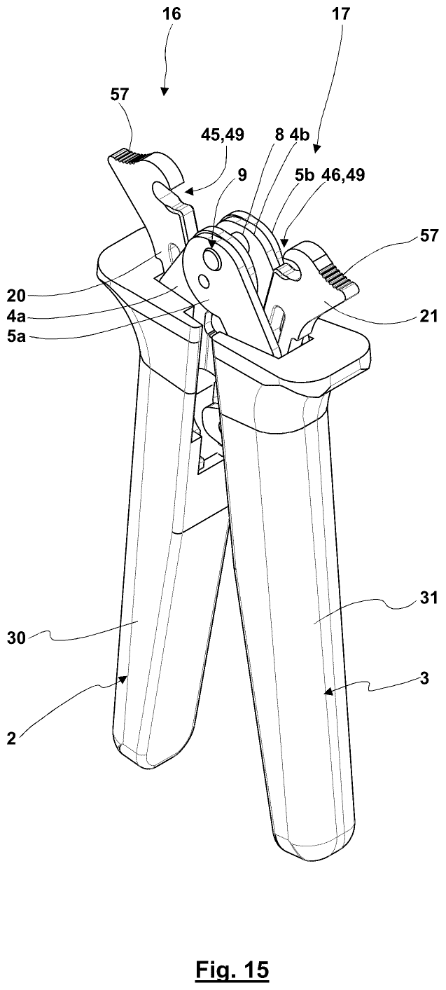

The pliers actuation assembly group 1 shown in FIGS. 14 and 15 has pulling bars 16, 17 that do not have coupling elements 22, 23 embodied as coupling pins 26, 27. Instead, for this embodiment, the pulling bars 16, 17 comprise coupling recesses 45, 46, which are formed here as an elongated hole 49 open on one side. In this case, the coupling recesses 45, 46 are inclined at an acute angle 50 with respect to a radial direction to the pivot axis of the pivot bearings 18, 19 through the bottom of the coupling recess 45, 46, the acute angle preferably being in the range of 30° to 85° or 40° to 80° or 50° to 80°. As can be seen, in this case the base body 20, 21 of the pulling bars 16, 17 has lateral protrusions forming the actuating elements 57. Otherwise, the pliers actuation assembly group 1 is designed in accordance with the pliers actuation assembly group 1 shown in FIGS. 1 and 2 and described with respect thereto.

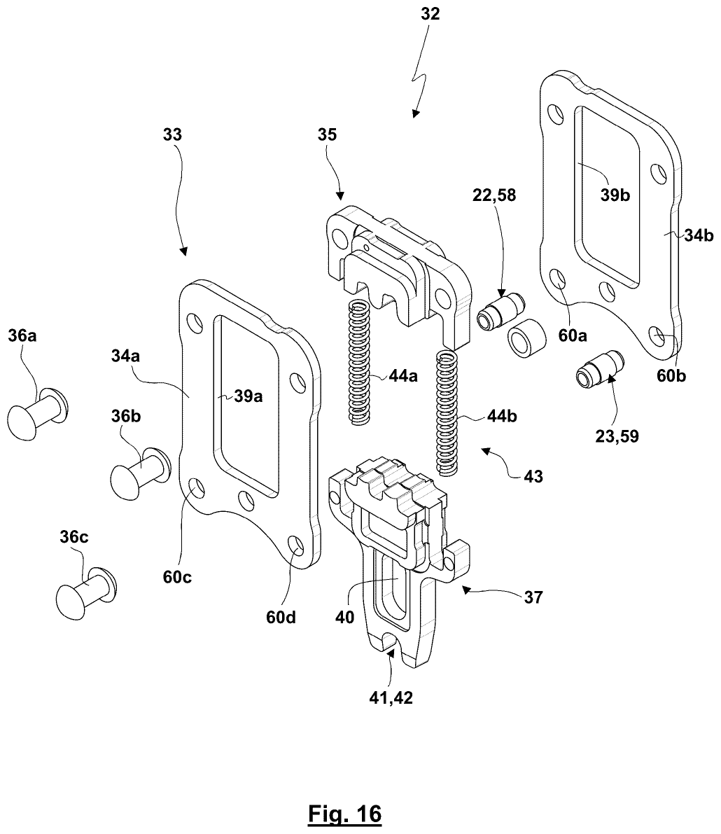

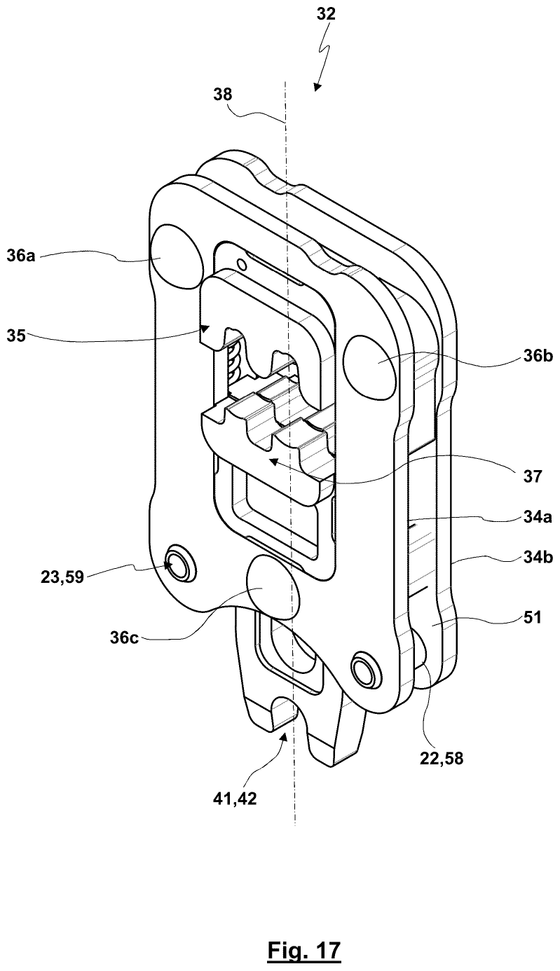

FIGS. 16 and 17 show the pliers head 32 for this embodiment. Here, the pliers head frame 33 does not have coupling recesses 45, 46. Instead, the pliers head frame 33 has coupling elements 22, 23 in the lower end region facing the pliers actuation assembly group 1 in the assembled state, which are formed as coupling pins 58, 59. Preferably, the coupling pins 58, 59 are multifunctional, in that they serve on the one hand as coupling elements for a coupling with the pliers actuation assembly group 1 and on the other hand serve for a connection to the frame plates 34a, 34b. For the embodiment shown, the coupling pins 58, 59 are stepped in the two end regions and are accommodated in a precisely fitting manner in corresponding bores 60a, 60b, 60c, 60d of the frame plates 34a, 34b, which are designed here as bores.

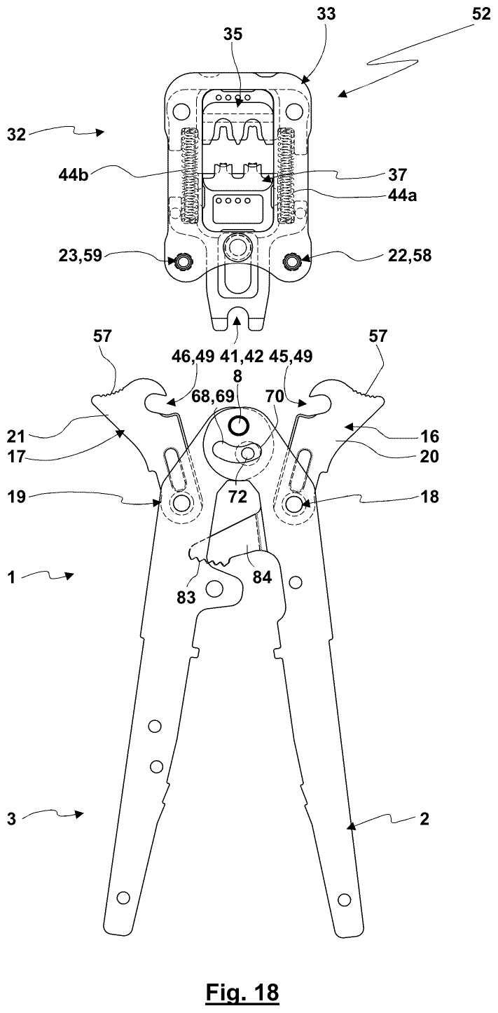

FIGS. 18 to 21 show the pliers 52 formed with the pliers head 32 and the pliers actuation assembly group 1 in various states of assembly:

According to FIG. 18, the pliers head 32 is disassembled from pliers actuation assembly group 1. The pivot bolt accommodation 41 of the pliers head 32 is freely accessible on the side facing the pliers actuation assembly group 1. The pivot bolt 8 and the pulling bars 16, 17 of the pliers actuation assembly group 1 are also freely accessible on the side facing towards the pliers head 32. The pulling bars 16, 17 can be pivoted freely in the plane of the pliers head.

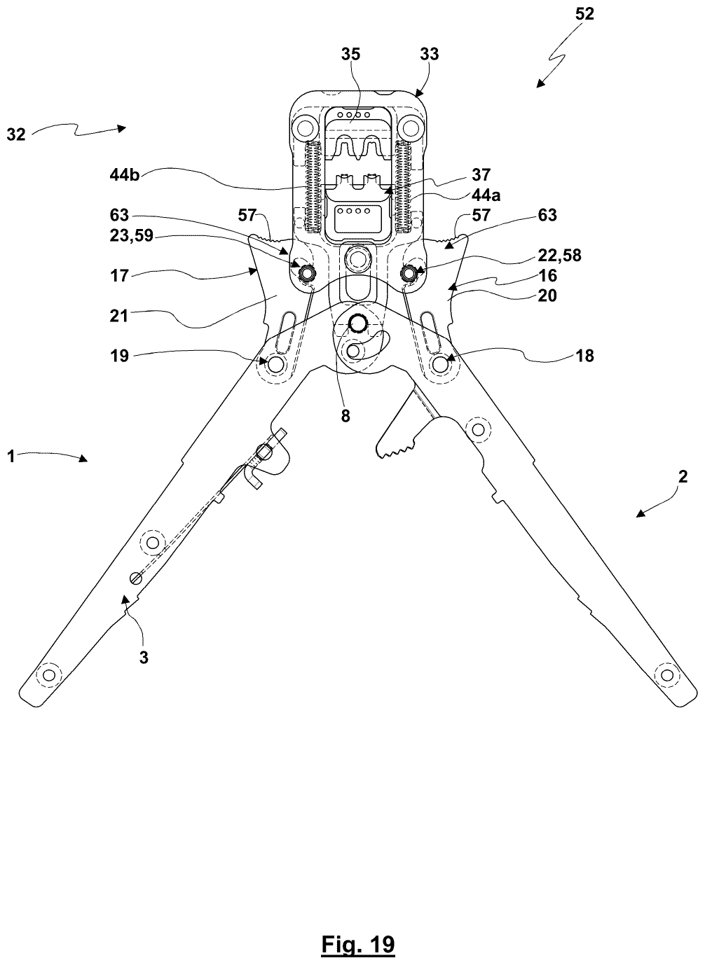

According to FIG. 19, the pliers actuation assembly group 1 has been approached to the pliers head 32 in such a way that the pivot bolt 8 enters the pivot bolt accommodation 41 and comes to rest against the bottom of the pivot bolt accommodation 41. In addition, the pulling bars 16, 17 are pivoted inwards, whereby the coupling pins 58, 59 of the pliers head 32 enter the coupling recesses 45, 46 of the pulling bars 16, 17. The length of the pulling bars 16, 17 is dimensioned in such a way that this entry is only possible when the movable die half 37 moves in the closing direction under the bias by the spring device 43. With regard to the extent of the closing movement and the force conditions what has been said with regard to the first embodiment applies accordingly.

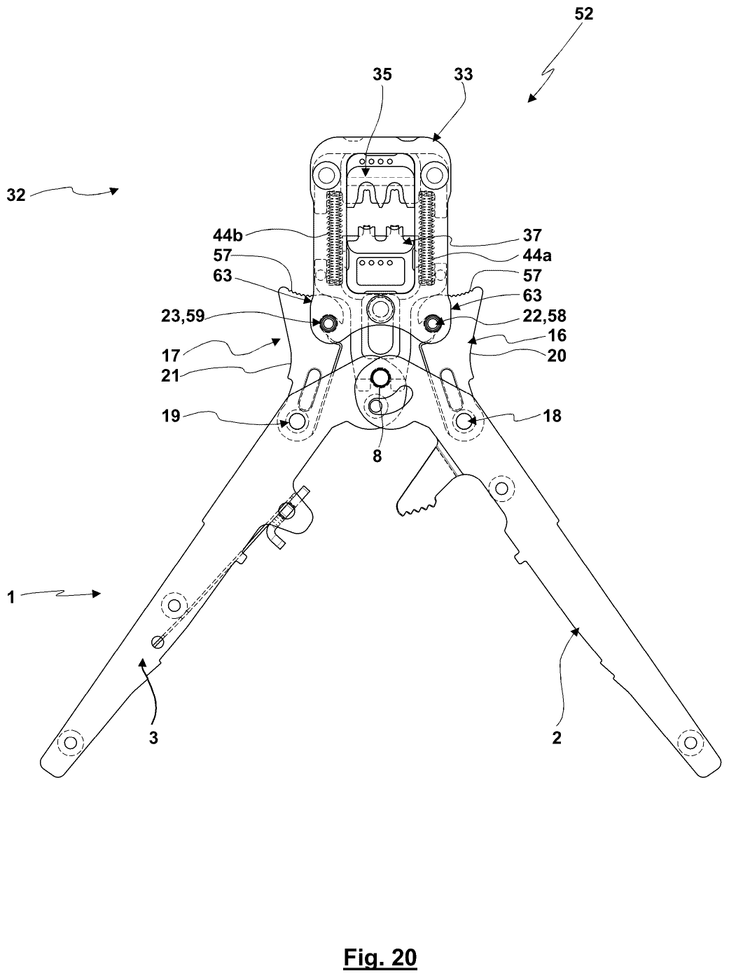

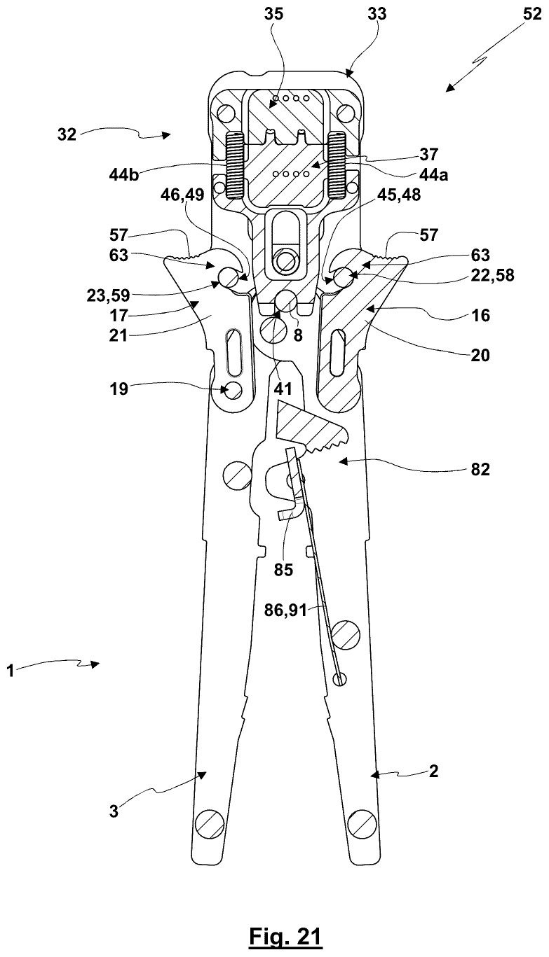

If the coupling pins 58, 59 contact the bottom of the coupling recesses 45, 46 in the fully assembled position as shown in FIG. 20, the spring device 43 secures the state assembled in this way. The pivoting of the hand levers 2, 3 towards each other then leads to the passage of the crimping or pressing stroke until the closed position shown in FIG. 21 is reached.

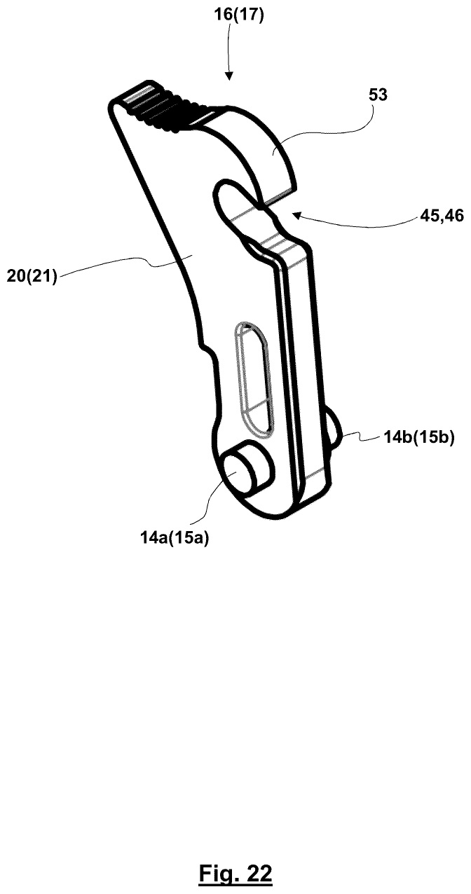

FIG. 22 shows the pulling bars 16, 17 as individual parts. The pulling bars 16, 17 are preferably formed in one piece with the base body 20, 21 and the pivot pins 14, 15 as well as the actuating element 57. Preferably, the pulling bars 16, 17 are produced in a MIN manufacturing process.

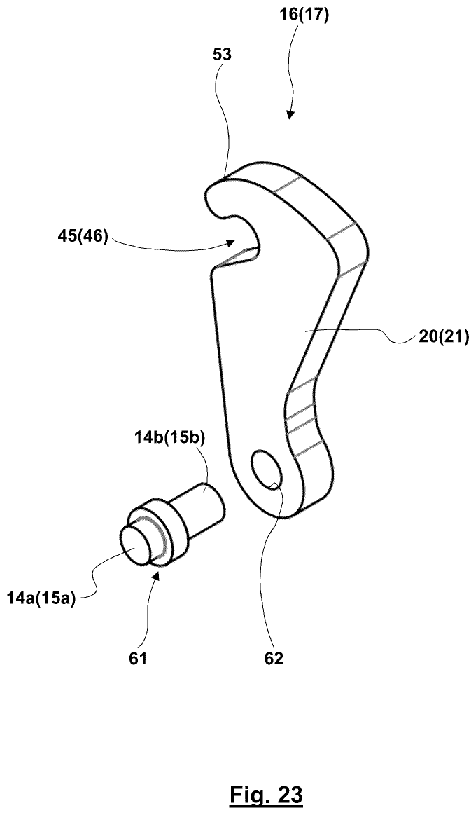

FIG. 23 shows an alternative design of the pulling bars 16, 17, wherein the base bodies 20, 21 and a pivot bolt 61 which forms the pivot pins 14, 15 are formed separately from one another. In this case, the base body 20, 21 can be manufactured, for example, as a milled or stamped part. The base body 20, 21 then has a bore 62 in which the pivot bolt 61 is accommodated with a fit, for example by means of a press fit.

Also for this embodiment, the pulling bars 16, 17 may have a contact surface 53 that comes into contact with a contact surface 54 of the movable die half 53 when the pulling bars 16, 17 are pivoted inward. The contact surface may generate an actuation force component that causes the movable die half 37 to move in the closing direction to allow the coupling pins 58, 59 to enter the coupling recesses 45, 46.

The coupling recesses 45, 46 and the coupling elements 22, 23 form coupling devices 63 by means of which the pliers head 32 can be assembled with and disassembled from the pliers actuation assembly group 1 (in particular without the use of any tool).

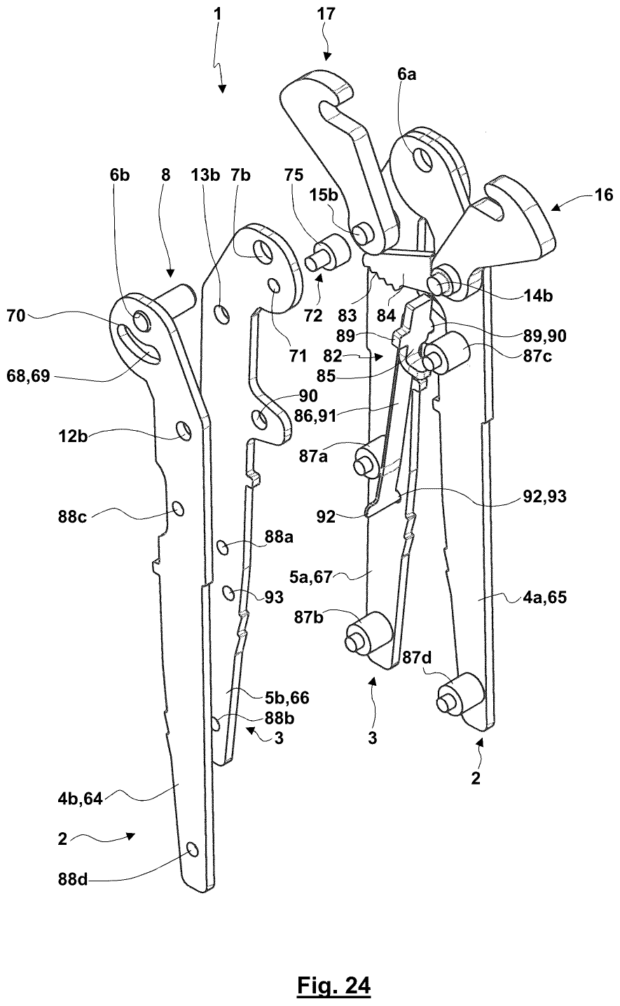

FIG. 24 shows a pliers actuation assembly group 1 in a three-dimensional exploded view, wherein the pliers actuation assembly group 1 basically corresponds to the embodiment described in FIGS. 14 to 23. However, the following also applies mutatis mutandis for an embodiment corresponding to the embodiment of FIGS. 1 to 13.

In the nomenclature on the one hand of the patent claims and on the other hand of the preceding description od the figures, the hand lever plate 4b of the hand lever 2 forms a first hand lever plate 64, the hand lever plate 4a of the hand lever 2 forms a second hand lever plate 65, the hand lever plate 5b of the hand lever 3 forms a third hand lever plate 66, and the hand lever plate 5a of the hand lever 3 forms a fourth hand lever plate 67.

The first hand lever plate 64 has a recess 68 embodied as an elongated hole 69. An end region of the elongated hole 69 forms a stop 70. The elongated hole 69 has a longitudinal axis curved in the shape of an arc of a circle, which runs concentrically to the pivot axis of the two hand levers 2, 3 defined by the pivot bolt 8.

The third hand lever plate 66 has a holding and/or guiding recess, which is here embodied as a holding and/or guiding bore 71. The distance of the holding and/or guiding bore 71 from the pivot axis defined by the pivot bolt 8 corresponds to the distance of the elongated hole 69 from the pivot axis defined by the pivot bolt 8.

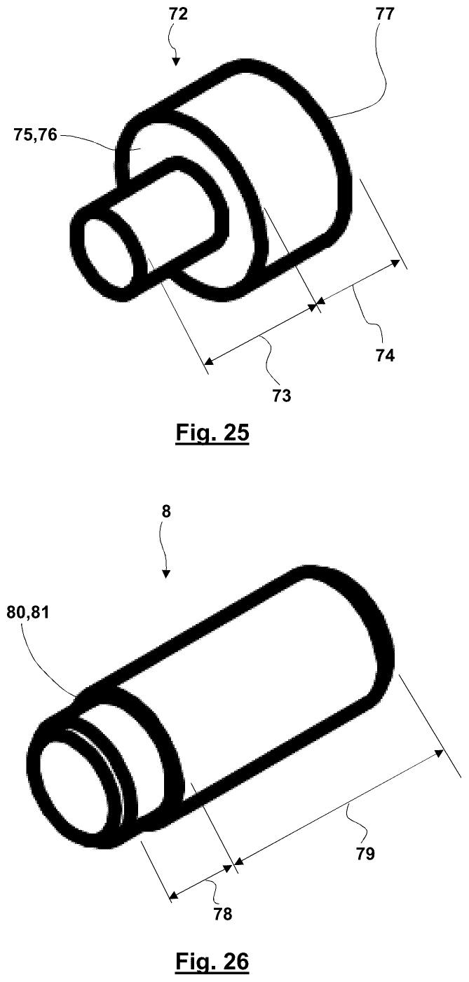

FIG. 25 shows a stop part 72. The stop part 72 comprises or consists of a first longitudinal cylindrical longitudinal section 73 having a first diameter and a second cylindrical longitudinal section 74 having a second diameter being larger than the first diameter. The longitudinal sections 73, 74 are arranged coaxially with respect to each other. The transition from the first longitudinal section 73 to the second longitudinal section 74 is provided by a shoulder 75, which is formed here by a circular ring surface 76. With the assembly, the first longitudinal section 73 is inserted into the holding and/or guiding bore 71 from the inside, i.e. from the side of the second and fourth hand lever plates 65, 67, whereby in particular a radial guidance of the stop part 71 is provided and the position of the stop part 72 in the pivot plane of the hand levers 2, 3 is defined as well as the orientation of the stop part 72 vertically to this pivot plane is guaranteed. The stop part 72 is inserted into the holding and/or guiding bore 71 to such an extent that the shoulder 72 comes into contact with the third hand lever plate 66 on the inner side of the third hand lever plate 66, i.e. on the side facing towards the hand lever plates 65, 67. In this way the free end region of the first longitudinal section 73 protrudes from the third hand lever plate 66 and is arranged in the elongate hole 69. Preferably, the front side of the first longitudinal section 73 is arranged flush with the outer surface of the first hand lever plate 64.

The free end face of the second longitudinal section 74 forms a support surface 77 (circular in this case). In the assembled state of the pliers actuation assembly group 1, the support surface 77 contacts the second hand lever plate 65. In the direction of insertion of the stop part 72 into the third hand lever plate 66, in the assembled state the stop part 72 is secured by the abutment of the shoulder 75 against the third hand lever plate 66, while a securing in the opposite direction is provided by the abutment of the support surface 77 against the second hand lever plate 65, so that the stop part 72 is trapped between the second hand lever plate 65 and the third hand lever plate 66.

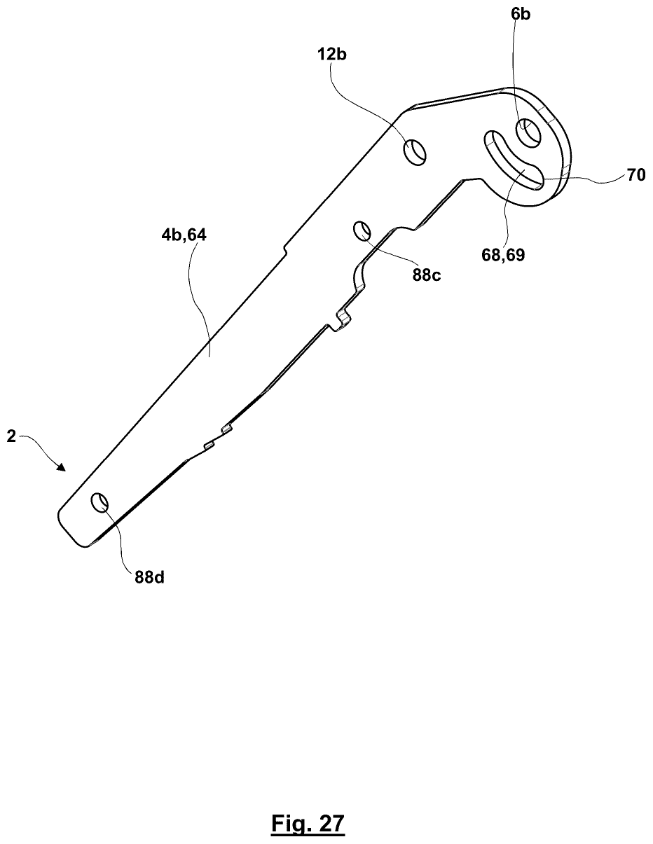

FIG. 26 shows a three-dimensional representation of the pivot bolt 8. It can be seen here that the pivot bolt 8 has a first cylindrical longitudinal section 78 and a second cylindrical longitudinal section 79, which are separated from each other by a shoulder 80, which is formed as an annular ring surface 81.

When assembling the pliers actuation assembly group 1, the pivot bolt 8 is inserted with the first longitudinal section 78 into the bearing eye 6b until the annular ring surface 81 on the inside comes into contact with the first hand lever plate 64. Subsequently, the second, third and fourth hand lever plates 65, 66, 67 are pushed with the bearing eyes 7b, 6a, 7a onto the pivot bolt 8.

For the embodiment shown, the pliers actuation assembly group 1 has a forced locking mechanism 82. Such a forced locking mechanism 82 serves to ensure that a partially closed position of the hand levers 2, 3, once reached, is secured in several partial stages during the pressing or crimping stroke, so that no opening movement of the hand levers 2, 3 is possible even if the manual forces applied to the hand levers 2, 3 are reduced. Instead, the forced locking mechanism 82 only allows an opening movement of the hand levers 2, 3 when the pressing or crimping stroke has been completed or when it has reached a defined closed position.

The forced locking mechanism 82 has a toothing 83, which is formed here by a protrusion 84 of the second hand lever plate 65. Furthermore, the forced locking mechanism 82 has a locking pawl 85. The locking pawl 85 is pivotably mounted and is biased by a spring 86. The locking pawl 85 interacts with the toothing 83 in such a way that during the closing movement of the hand levers 2, 3, when a partial closing position to be secured is reached, the locking pawl 85 has passed a tooth of the toothing 83 in a ratchet-like manner, while the locking pawl 85 blocks an opening movement by suitable support on the tooth that has passed. Once the locking pawl 85 has passed all the teeth of the toothing 83 with the completion of the closing stroke, the locking pawl 85 can fold over, allowing the locking pawl 85 to pass the toothing 83 of the hand levers 2, 3 in a ratchet-like manner during an opening movement that is then made possible.

The assembly of the pliers actuation assembly group 1 is described below, the corresponding applying to the embodiments shown in FIGS. 1 to 23:

Assembly begins with the provision of the first hand lever plate 64 (cf. FIG. 27).

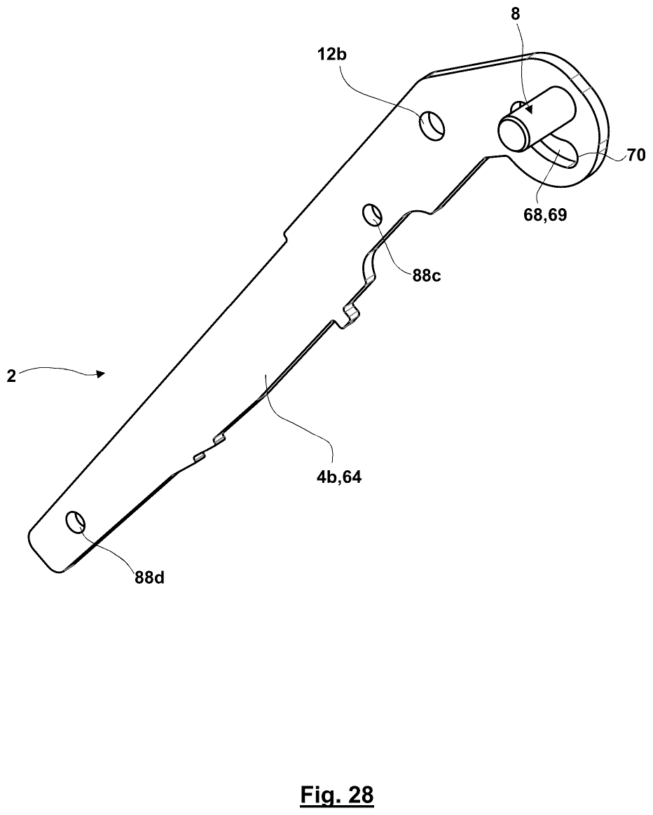

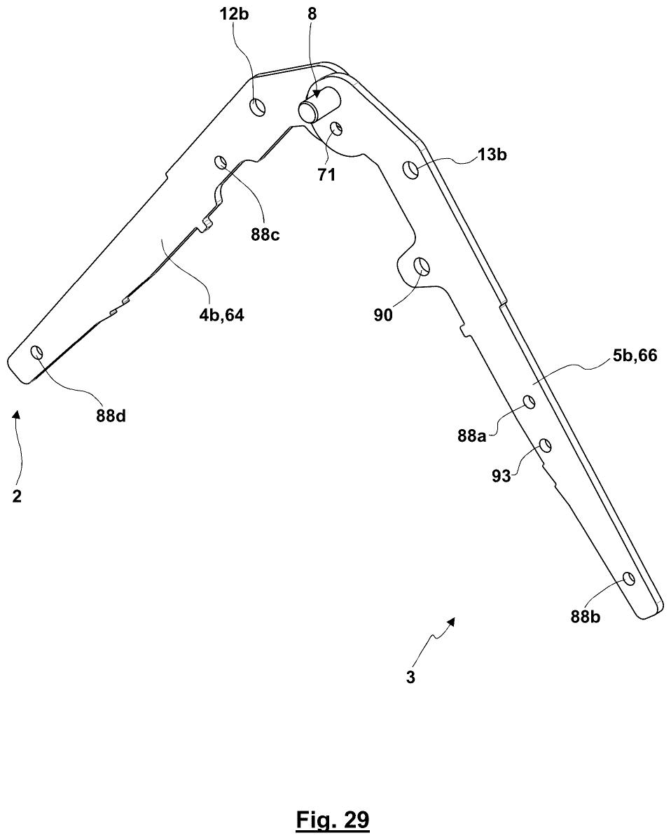

The first longitudinal section 78 of the pivot bolt 8 is then inserted into the bearing eye 6b of the first hand lever plate 64 from the inside of the first hand lever plate 64 until the shoulder 80 of the pivot bolt 8 comes into contact with the hand lever plate 64 (cf. FIG. 28).

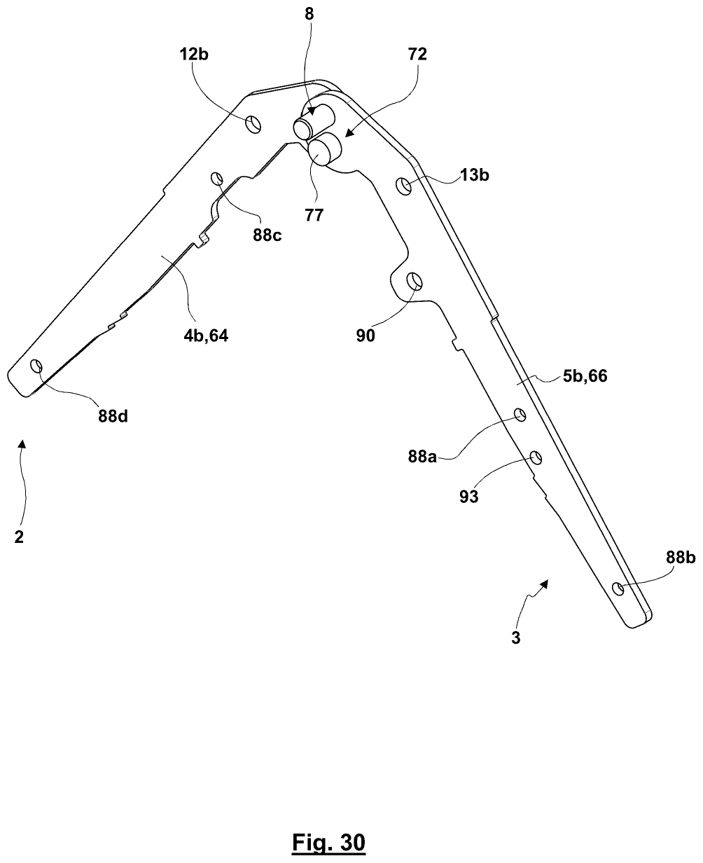

Subsequently, the third hand lever plate 66 is pushed from the inside onto the pivot bolt 8, whereby the pivot bolt 8 enters the bearing eye 7b. FIG. 29 shows the end position of the third hand lever plate 66, in which the first and third hand lever plates 64, 66 rest against each other in a sliding manner under the guidance by the pivot bolt 8.

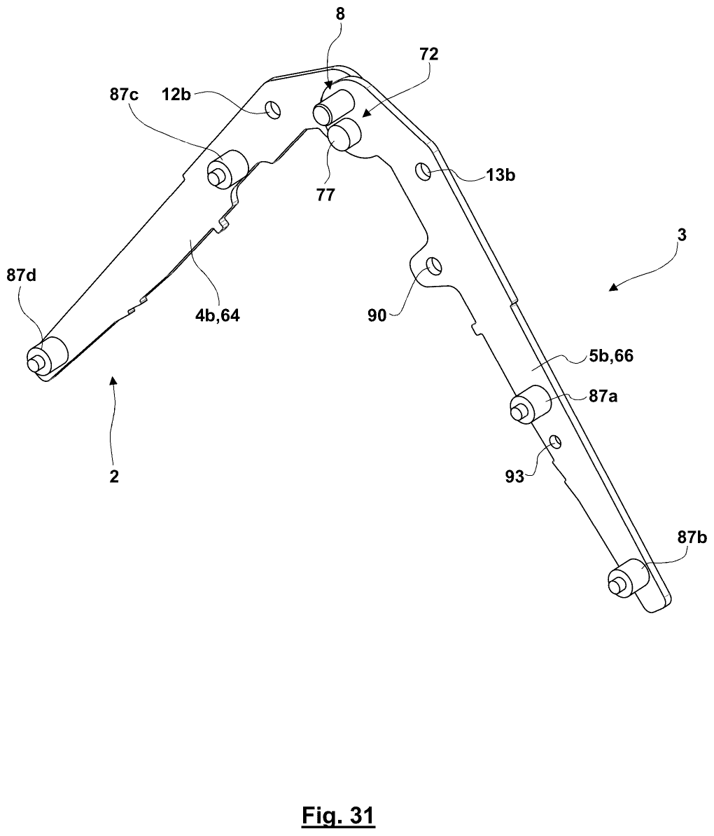

In the next assembly step, the first longitudinal section 73 of the stop part 72 is inserted from the inside into the holding and/or guiding bore 71 and guided through it until the free end region of the first longitudinal section 73 is received in the elongated hole 69 (cf. FIG. 30).

Referring to FIG. 31, spacers 87a, 87b, 87c, 87d are then inserted into accommodations 88a, 88b, 88c, 88d. For the embodiment shown, the spacers 87 each have a central cylindrical longitudinal section, the longitudinal extension defining the distance of the second hand lever plate 65 from the third hand lever plate 66, and each have cylindrical end sided longitudinal sections which form pins or journals which are accommodated in the accommodations 88 of the hand lever plates 64, 66 (and later also of the hand lever plates 65, 67), which are embodied as bores. In this case, the pins or journals have a smaller diameter than the central longitudinal section, so that the central longitudinal section transits to the pins or journals via a shoulder, here in the form of a circular ring surface. These shoulders are then trapped between the second and third hand lever plates 65, 66, whereby the spacers 87 between the hand lever plates 65, 66 are secured against disassembly in a direction vertical to the pivot plane of the hand levers 2, 3. The spacers 87 then define the intermediate space between the pairs of hand lever plates 64, 66 and 65, 67, which can be pivoted relative to one another.

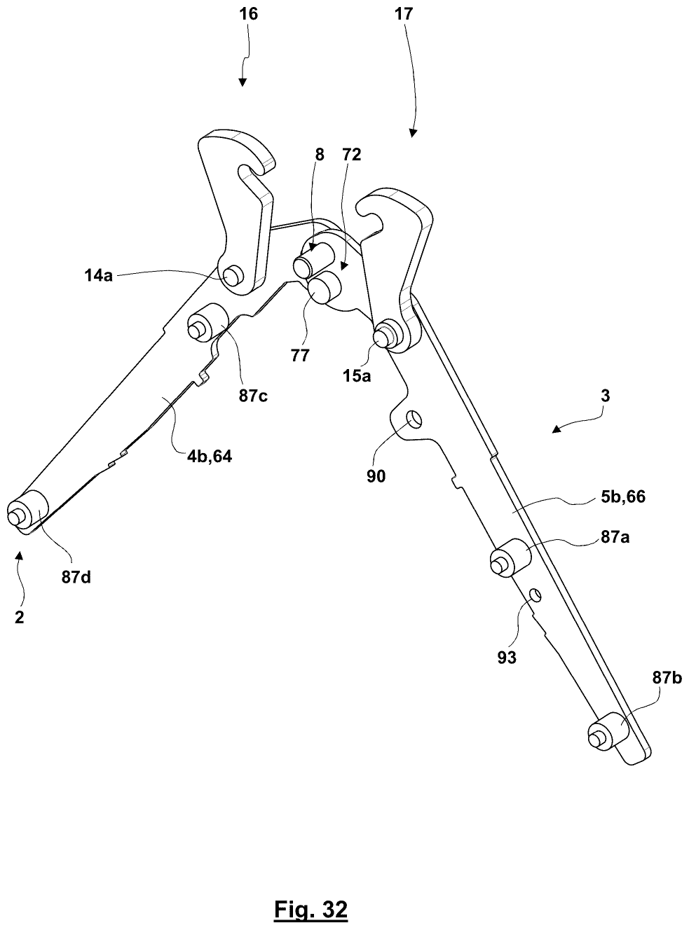

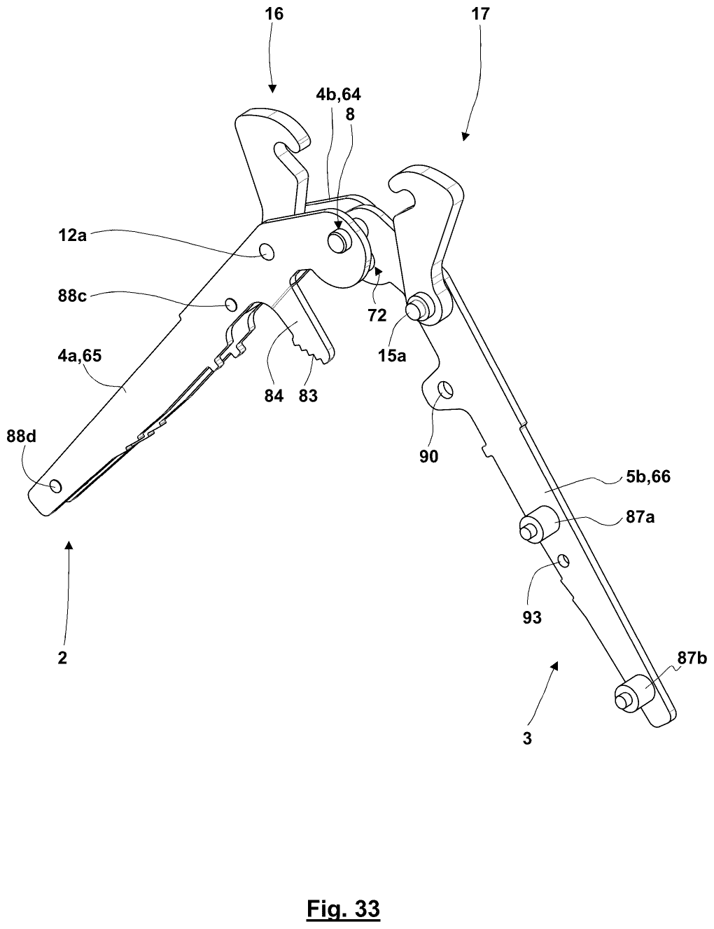

According to FIG. 32, the pivot pins 14b, 15b of the pulling bars 16, 17 are then inserted into the bores 12b, 13b.

In the next assembly step, the second hand lever plate 65 is joined. During this joining step, the bearing eye 6a of the second hand lever plate 65 is pushed onto the pivot bolt 8. At the same time, the pivot pin 14a enters into the bore 12a of the second hand lever plate 65 and the pins of the spacers 87a, 87b enter into the recesses 88c, 88d of the second hand lever plate 65. The assembly state then achieved is shown in FIG. 33.

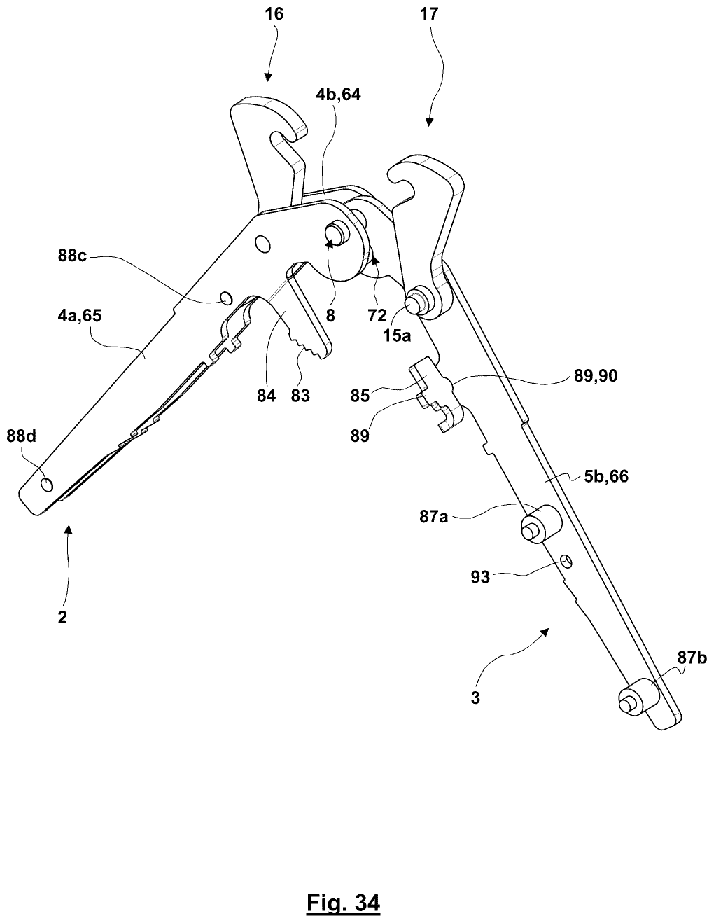

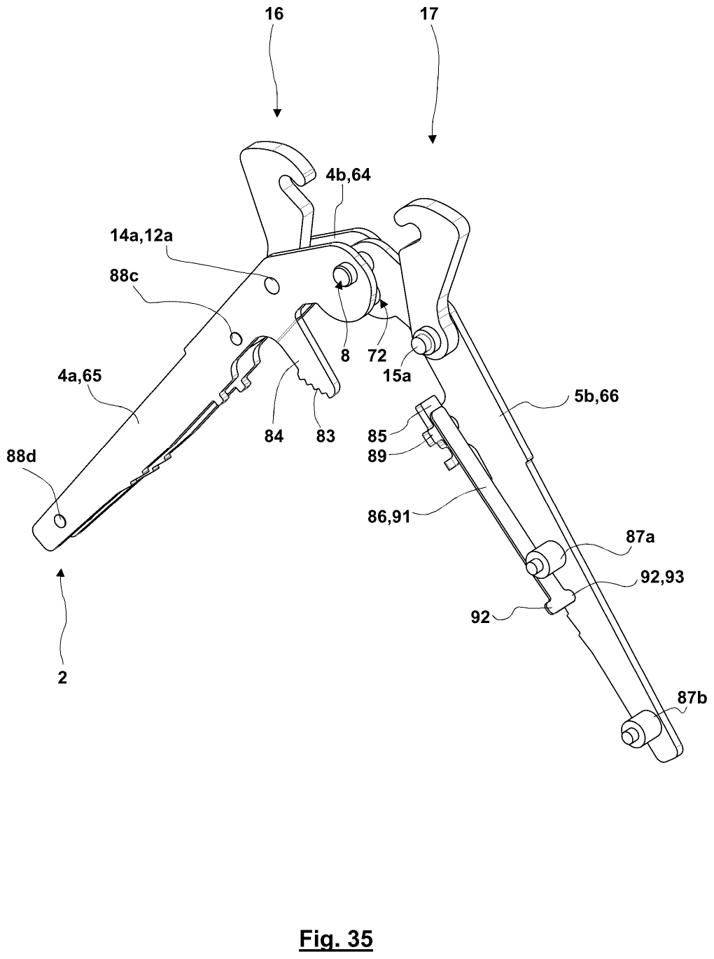

In the next assembly step, the locking pawl 85 is assembled with the third hand lever plate 66 by accommodating a protrusion 89 of the locking pawl 85 in an accommodation 90 of the third hand lever plate 66 (cf. FIG. 34).

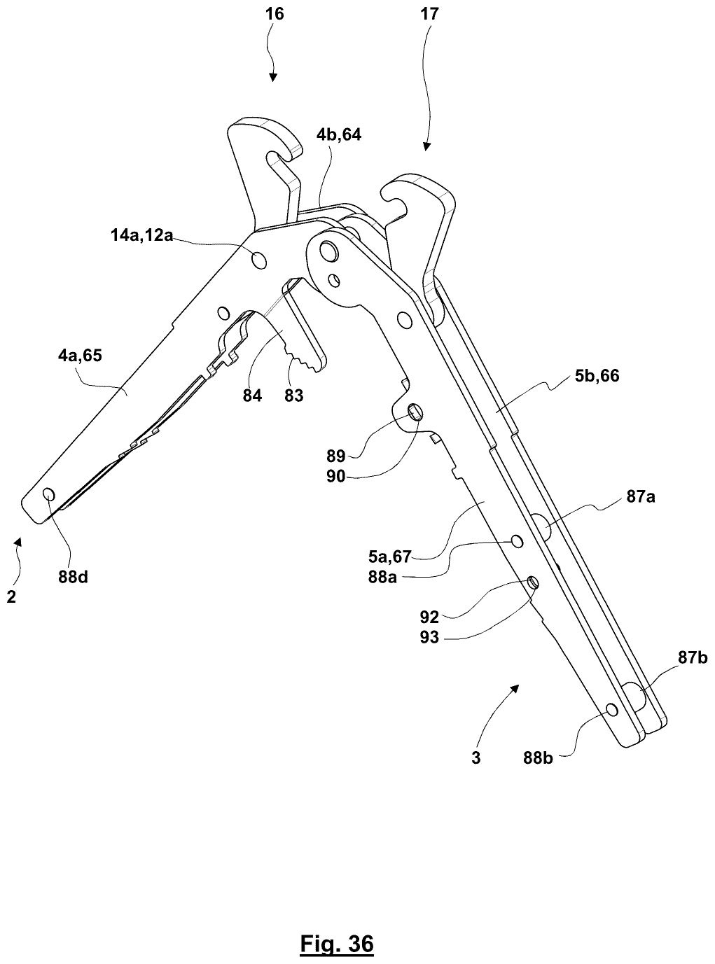

Subsequently, the spring 86 is assembled. In the embodiment shown, the spring 86 is embodied as a leaf spring 91. One spring base of the leaf spring 91 comprises a protrusion 92 which is received in an accommodation 93 of the third hand lever plate 66. Furthermore, the leaf spring 91 is supported adjacent to the protrusion 92 on a spacer 87 in the bending direction of the leaf spring 91. The leaf spring 91 protrudes freely and is supported in the end region facing away from the protrusion 92 on the locking pawl 85 under the bias of the latter (see FIG. 35).

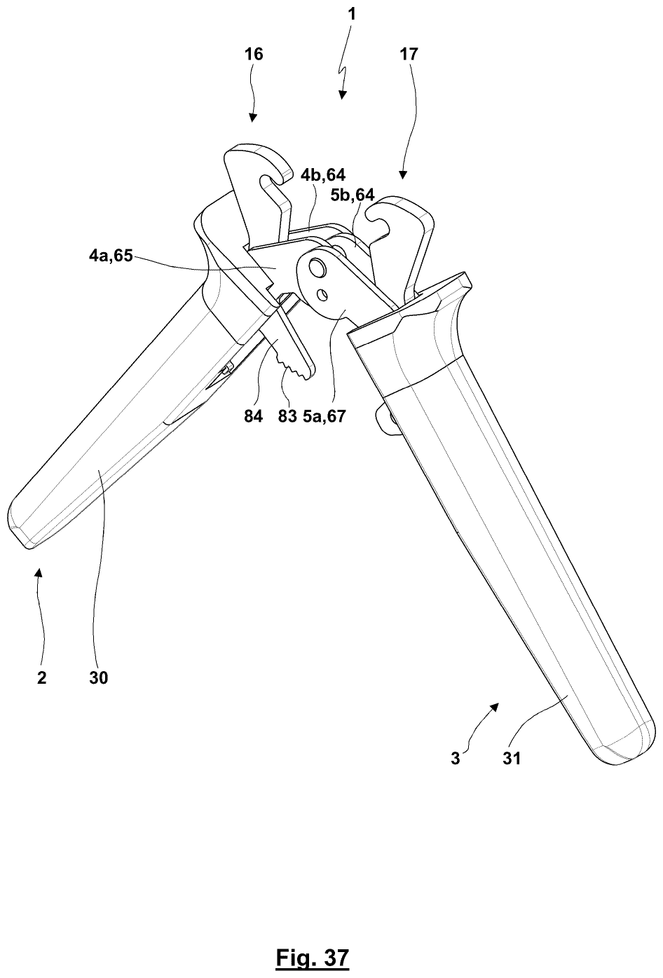

Subsequently, the fourth hand lever plate 67 is mounted onto the pivot bolt 8. With this mounting, pins of the spacers 87c, 87d enter accommodations 88a, 88b of the fourth hand lever plate 67, a further protrusion 89 of the locking pawl 85 enters an accommodation 90 of the fourth hand lever plate 67 and a pivot pin 15a enters an bore 13a of the fourth hand lever plate 67 (see FIG. 36).

In the assembly state reached in this way (or also partially already before), the hand lever plates 64, 65, 66, 67 are then fixed. This is done, for example, by connecting (in particular by pressing clamping, screwing or riveting and the like) the spacers 87 in the accommodations of the hand lever plates 64, 65, 66, 67. In addition, the pivot bolt 8 can also be pressed fitted or clamped. However, this must be done while maintaining the degree of pivot freedom of the hand levers 2, 3.

Finally, the handles 30, 31 are slid onto the hand lever plates 64, 65, 66, 67 (FIG. 37).

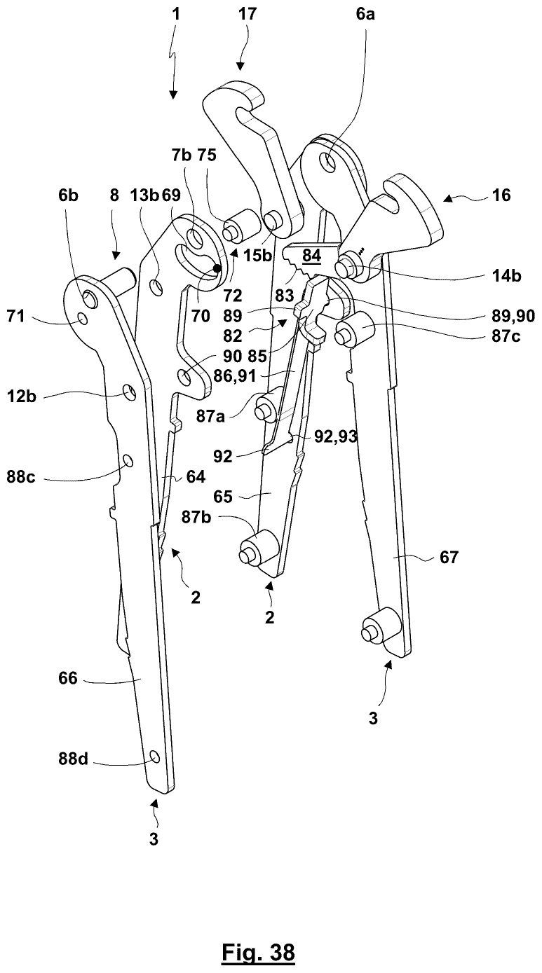

FIG. 38 shows an alternative embodiment of a pliers actuation assembly group 1. For this embodiment the cylindrical section of the stop part 72 arranged in front of the shoulder 75 only extends in a holding and/or guiding bore 71 of the third hand lever plate 66 on which der shoulder 75 is supported in outer direction. The cylindrical section of the stop part 72 with the larger diameter is in this case accommodated in the elongated hole 69 and guided therein. In this case the end-sided supporting surface 77 of the stop part 72 is guided in a sliding fashion on the fourth hand lever plate 67. The stop part 72 is accordingly trapped and secured between the contact of the shoulder 75 with the third hand lever plate 66 and the contact of the supporting surface 77 with the fourth hand lever plate 67.

A pivotable assembly of a spring 86 of the forced locking mechanism, a locking pawl 85 of the forced locking mechanism and/or of pulling bars 16, 17 in recesses or bores of hand lever plates 64, 65 or 66, 67 of a hand lever 2, 3 can also take place. The spring 86, the locking pawl 85 and/or the pulling bars 16, 17 are then trapped between the two hand lever plates 64, 65 or 66, 67, as this is the subject of the European patent application EP 22 207 540 filed on the same day by of the applicant, which is made the subject of the present patent application in this respect.

Many variations and modifications may be made to the preferred embodiments of the invention without departing substantially from the spirit and principles of the invention. All such modifications and variations are intended to be included herein within the scope of the present invention, as defined by the following claims.

I claim:

1. A pliers actuation assembly group which can be coupled to a pliers head to form pliers in such a way that a stroke of die halves of the pliers head can be brought about by means of a manual actuation of the pliers actuation assembly group, with
a) two hand levers, wherein
aa) one hand lever has a first hand lever plate and a second hand lever plate which are rigidly connected to one another,
ab) the other hand lever has a third hand lever plate and a fourth hand lever plate which are rigidly connected to one another, and
ac) the first, second, third and fourth hand lever plates are arranged parallel to one another,
b) a pivot bolt via which the hand levers are pivotably connected to one another,
c) a stop formed by the first hand lever plate and a stop part held and/or guided on the third hand lever plate, the stop and the stop part coming into contact with one another to limit an opening angle of the hand levers,
wherein at least one of the stop part and the pivot bolt has a shoulder which in the assembled state of the pliers actuation assembly group contacts the third hand lever plate for providing a support in a direction vertical to a pivot plane of the hand levers.

2. The pliers actuation assembly group of claim 1, wherein the first, second, third and fourth hand lever plates are arranged in parallel planes in the following order in a direction vertical to the pivot plane of the hand levers:
a) the first hand lever plate, the third hand lever plate, the second hand lever plate, the fourth hand lever plate or
b) the first hand lever plate, the third hand lever plate, the fourth hand lever plate, the second hand lever plate.

3. The pliers actuation assembly group of claim 2, wherein the stop part
a) comprises a first longitudinal section extending through the third hand lever plate and interacting with the stop of the first hand lever plate in an end region projecting from the third hand lever plate, and
b) comprises a second longitudinal section which is connected to the first longitudinal section via the shoulder and which in an end region facing away from the first longitudinal section comprises a supporting surface which contacts the second or fourth hand lever plate, so that the stop part is trapped in both directions vertical to the pivot plane of the hand levers between the third hand lever plate contacted by the shoulder and the second or fourth hand lever plate contacted by the supporting surface.

4. The pliers actuation assembly group of claim 1, wherein the first, second, third and fourth hand lever plates are arranged in the following order in a direction vertical to the pivot plane of the hand levers:
a) the third hand lever plate, the first hand lever plate, the second hand lever plate, the fourth hand lever plate or
b) the third hand lever plate, the first hand lever plate, the fourth hand lever plate, the second hand lever plate.

5. The pliers actuation assembly group of claim 4, wherein the stop part
a) comprises a first longitudinal section extending into the third hand lever plate, and
b) comprises a second longitudinal section, which is connected to the first longitudinal section via the shoulder, extends through the first hand lever plate and has a support surface in an end region facing away from the first longitudinal section which contacts the second or fourth hand lever plate, so that the stop part is trapped in both directions vertical to the pivot plane of the hand levers between the third hand lever plate contacted by the shoulder and the second or fourth hand lever plate contacted by the support surface.

6. The pliers actuation assembly group of claim 3, wherein the stop part is a bolt having a first longitudinal cylindrical section with a first diameter and a second longitudinal cylindrical section with a second diameter, the second diameter being larger than the first diameter and the shoulder being formed between the longitudinal sections, the shoulder having a circular ring shape.

7. The pliers actuation assembly group of claim 5, wherein the stop part is a bolt having a first longitudinal cylindrical section with a first diameter and a second longitudinal cylindrical section with a second diameter, the second diameter being larger than the first diameter and the shoulder being formed between the longitudinal sections, the shoulder having a circular ring shape.

8. The pliers actuation assembly group according to claim 1, wherein the stop of the first hand lever plate is formed by an edge boundary of a recess of the first hand lever plate.

9. The pliers actuation assembly group of claim 8, wherein the recess is an elongated hole, which has a curved longitudinal axis arranged concentrically to a pivot axis of the hand levers defined by the pivot bolt.

10. The pliers actuator assembly group according to claim 1, wherein the pivot bolt has two shoulders, which are trapped between two hand levers plates.

11. Pliers comprising a pliers actuation assembly group with
a) two hand levers, wherein
aa) one hand lever has a first hand lever plate and a second hand lever plate which are rigidly connected to one another,
ab) the other hand lever has a third hand lever plate and a fourth hand lever plate which are rigidly connected to one another, and
ac) the first, second, third and fourth hand lever plates are arranged parallel to one another,
b) a pivot bolt via which the hand levers are pivotably connected to one another,
c) a stop formed by the first hand lever plate and a stop part held and/or guided on the third hand lever plate, the stop and the stop part coming into contact with one another to limit an opening angle of the hand levers,
d) wherein at least one of the stop part and the pivot bolt has a shoulder which in the assembled state of the pliers actuation assembly group contacts the third hand lever plate for providing a support in a direction vertical to a pivot plane of the hand levers,
the pliers actuation assembly group being coupled to a pliers head in such a way that a stroke of die halves of the pliers head can be brought about by means of a manual actuation of the pliers actuation assembly group.

12. A method of assembling a pliers actuator assembly group which can be coupled to a pliers head to form pliers in such a way that a stroke of die halves of the pliers head can be brought about by means of a manual actuation of the pliers actuation assembly group, the pliers actuator assembly group comprising
a) two hand levers, wherein
aa) one hand lever has a first hand lever plate and a second hand lever plate which are rigidly connected to one another,
ab) the other hand lever has a third hand lever plate and a fourth hand lever plate which are rigidly connected to one another, and
ac) the first, second, third and fourth hand lever plates are arranged parallel to one another,
b) a pivot bolt via which the hand levers are pivotably connected to one another,
c) a stop formed by the first hand lever plate and a stop part held and/or guided on the third hand lever plate, the stop and the stop part coming into contact with one another to limit an opening angle of the hand levers,
d) wherein at least one of the stop part and the pivot bolt has a shoulder which in the assembled state of the pliers actuation assembly group contacts the third hand lever plate for providing a support in a direction vertical to a pivot plane of the hand levers,
the method comprising the following method steps:
inserting the pivot bolt into a bearing eye of the first hand lever plate;
pushing the third hand lever plate onto the pivot bolt;
inserting the stop part in such a way that a first longitudinal section extends into a recess or into an elongated hole of the first hand lever plate and through a holding and/or guiding bore of the third hand lever plate, the shoulder being supported on the third hand lever plate;
pushing the second hand lever plate and the fourth hand lever plate onto the pivot bolt and blocking the support surface of a second longitudinal section of the stop part by the second hand lever plate or fourth hand lever plate from unwanted disassembly;
fixing the first and second hand lever plates to each other and fixing the third and fourth hand lever plates to each other, whereby the pivot bolt and/or the stop part are trapped between two hand lever plates.
